(19) United States
(12) Patent Application Publication
(10) Pub. No.: US 2026/0262000 A1
(43) Pub. Date: Sep. 3, 2026

(54) SESSION SELECTION FOR HYBRID-BASED RANGING IN UWB

(71) Applicant: QUALCOMM Incorporated, San Diego, CA (US)

(72) Inventors: Varun Amar REDDY, San Diego, CA (US); Alexandros MANOLAKOS, Athens, Attikí (GR); Pooria PAKROOH, San Marcos, CA (US); Krishna Kiran MUKKAVILLI, San Diego, CA (US)

(21) Appl. No.: 18/713,846

(22) PCT Filed: Feb. 14, 2023
(86) PCT No.: PCT/US2023/062612

§ 371 Date: May 28, 2024

(30) Foreign Application Priority Data
Feb. 24, 2022 (GR) 20220100167
Mar. 3, 2022 (GR) 20220100197
Mar. 31, 2022 (GR) 20220100287

(51) Int. Cl. H04W 64/00; H04B 1/7163

(52) U.S. Cl. CPC H04W 64/00; H04B 1/7163

(57) ABSTRACT

In some implementations, a first UWB device may obtain session information for each candidate UWB positioning session of a plurality of candidate UWB positioning sessions, wherein the session information for each candidate UWB positioning session is based at least in part on one or more session parameters included within a message regarding the respective candidate UWB positioning session received at the first UWB device. The UWB device may determine a priority for each candidate UWB positioning session of the plurality of candidate UWB positioning sessions based at least in part on the session information for each candidate UWB positioning session of a plurality of candidate UWB positioning sessions.

### RELATED APPLICATIONS

This This application claims the benefit of Greek Application No. 20220100167, filed Feb. 24, 2022, entitled “SESSION SELECTION FOR HYBRID-BASED RANGING IN UWB”, Greek Application No. 20220100287, filed Mar. 31, 2022, entitled “TIME ALIGNMENT CONFIGURATION FOR HYBRID CELLULAR AND UWB POSITIONING”, and Greek Application No. 20220100197, filed Mar. 3, 2022, entitled “CLOUD-CENTRIC DESIGN FOR HYBRID NR AND UWB POSITIONING”, all of which are assigned to the assignee hereof, and incorporated herein in their entirety by reference.

### BACKGROUND

### 1. Field of Disclosure

The present disclosure relates generally to the field of radiofrequency (RF)-based position determination (or positioning) of an electronic wireless device. More specifically, the present disclosure relates to ultra-wideband (UWB)-based positioning.

### 2. Description of Related Art

UWB-based positioning offers a highly-accurate, low-power positioning solution relative to other RF-based positioning techniques for wireless electronic devices. UWB-based positioning can be used in industrial applications, such as by robots and/or other Internet of Things (IoT) devices in a factory setting, indoor positioning of consumer electronics, and more. One or more UWB positioning sessions (or simply “UWB sessions”) may be conducted to perform the UWB-based positioning, and a given UWB device may have an opportunity to participate in several UWB sessions.

### BRIEF SUMMARY

An example method of ultra-wideband (UWB) positioning session prioritization for a first UWB device, according to this disclosure, may comprise obtaining session information for each candidate UWB positioning session of a plurality of candidate UWB positioning sessions, wherein the session information for each candidate UWB positioning session is based at least in part on one or more session parameters included within a message regarding the respective candidate UWB positioning session received at the first UWB device. The method also may comprise determining a priority for each candidate UWB positioning session of the plurality of candidate UWB positioning sessions based at least in part on the session information for each candidate UWB positioning session of a plurality of candidate UWB positioning sessions.

An example device comprising: a transceiver, a memory, one or more processors communicatively coupled with the transceiver and the memory, wherein the one or more processors are configured to obtain session information for each candidate ultra-wideband (UWB) positioning session of a plurality of candidate UWB positioning sessions, wherein the session information for each candidate UWB positioning session is based at least in part on one or more session parameters included within a message regarding the respective candidate UWB positioning session received at a first UWB device, and determine a priority for each candidate UWB positioning session of the plurality of candidate UWB positioning sessions based at least in part on the session information for each candidate UWB positioning session of a plurality of candidate UWB positioning sessions.

An example apparatus for ultra-wideband (UWB) positioning session prioritization for a first UWB device, according to this disclosure, may comprise means for obtaining session information for each candidate UWB positioning session of a plurality of candidate UWB positioning sessions, wherein the session information for each candidate UWB positioning session is based at least in part on one or more session parameters included within a message regarding the respective candidate UWB positioning session received at the first UWB device, and means for determining a priority for each candidate UWB positioning session of the plurality of candidate UWB positioning sessions based at least in part on the session information for each candidate UWB positioning session of a plurality of candidate UWB positioning sessions.

According to this disclosure, an example non-transitory computer-readable medium stores instructions for ultra-wideband (UWB) positioning session prioritization for a first UWB device, the instructions comprising code for obtaining session information for each candidate UWB positioning session of a plurality of candidate UWB positioning sessions, wherein the session information for each candidate UWB positioning session is based at least in part on one or more session parameters included within a message regarding the respective candidate UWB positioning session received at the first UWB device. The instructions further may comprise code for determining a priority for each candidate UWB positioning session of the plurality of candidate UWB positioning sessions based at least in part on the session information for each candidate UWB positioning session of a plurality of candidate UWB positioning sessions.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

The appended drawings are provided to complement the following description. It can be noted that, the term “background” is included in the text of many of the appended drawings to provide context for the embodiments described herein. It does not necessarily follow, however, that such information should be considered prior art. Some information identified as background in the appended drawings may, in fact, comprise novel features used by one or more embodiments described herein.

FIG. 1 is a diagram of a positioning system, according to an embodiment.

FIGS. 2A and 2B are simplified diagrams illustrating examples of how ultra-wideband (UWB) positioning/ranging may be performed in a network of UWB devices.

FIGS. 3A and 3B are flow diagrams illustrating how different devices may assume different roles with regard to a UWB positioning session.

FIG. 4A is illustration of different packet configurations that can be used in a UWB session at the UWB physical (PHY) layer.

FIG. 4B is an illustration of a deterministic random bit generator (DRBG) that can be used to generate a scrambled timestamp sequence (STS).

FIG. 5 is a timing diagram of how time may be measured and utilized within a UWB positioning session.

FIGS. 6A and 6B are timing diagrams illustrating how contention-based ranging using a Contention Access Period (CAP) may be implemented, according to some embodiments.

FIG. 7 is a timing diagram of a hybrid-based ranging round, according to some embodiments.

FIG. 8 is a timing diagram illustrating an example scenario in which a UWB device may utilize embodiments described herein for UWB positioning session prioritization, according to some embodiments.

FIG. 9 is a diagram of another example scenario in which a connected intelligent edge (CID) and UWB devices may utilize embodiments described herein for UWB positioning session prioritization, according to some embodiments.

FIG. 10 is a flow diagram of a method of method of UWB positioning session prioritization for a first UWB device, according to an embodiment.

FIG. 11 is a block diagram of an embodiment of a mobile UWB device, which can be utilized in embodiments as described herein.

FIG. 12 is a block diagram of an embodiment of a stationary UWB device, which can be utilized in embodiments as described herein.

FIG. 13 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IOT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “positioning reference signals,” “reference signals for positioning,” and the like may be used to refer to signals used for positioning of a mobile device, such as a UWB device. As described in more detail herein, such signals may comprise any of a variety of signal types. Additionally, unless otherwise specified, references to “sensing reference signals,” “reference signals for sensing,” and the like may be used to refer to signals used for RF sensing (also generically referred to herein as “sensing”) as described herein. A signal used for RF sensing and/or positioning may be generally referred to herein as a reference signal (RS). As described in more detail herein, such signals may comprise any of a variety of signal types but may not necessarily be limited to signals solely used for RF sensing.

Further, unless otherwise specified, the term “positioning,” “position determination,” “location determination,” “location estimation,” and the like, as used herein may include absolute location determination, relative location determination, ranging, or a combination thereof. Such positioning may include and/or be based on timing, angular, phase, or power measurements, or a combination thereof (which may include RF sensing measurements) for the purpose of location or sensing services.

As previously noted, UWB-based positioning offers a highly-accurate, low-power positioning solution relative to other RF-based positioning techniques for wireless electronic devices. UWB-based positioning can be used in industrial applications, such as by robots and/or other Internet of Things (IoT) devices in a factory setting, indoor positioning of consumer electronics, and more. One or more UWB positioning sessions (or simply “UWB sessions”) may be conducted to perform the UWB-based positioning, and a given UWB device may have an opportunity to participate in several UWB sessions. However, it may not be desirable for a UWB device to participate in every positioning session possible. Among other things, it can lead to inefficiencies in bandwidth usage, power consumption, and more. To address these and other issues, embodiments herein provide techniques by which a device can prioritize which UWB sessions to participate in using relevant decision metrics.

Various aspects of this disclosure relate generally to UWB positioning or ranging. Some aspects more specifically relate to UWB session selection in the UWB positioning. In some examples, a device (e.g., UWB device or server communicatively linked with a UWB device) may obtain session information from each of a plurality of candidate UWB-positioning sessions, and prioritize the positioning sessions based at least in part on session information for each session. This session information may comprise one or more of a variety of metrics, which may be included in control information sent by the controller for each session. The UWB device may then participate in the UWB sessions in accordance with their priority (e.g., in order of highest priority to lowest priority). A UWB device may refrain from participating in UWB sessions that do not have a threshold priority value and/or may participate in a number of UWB sessions at any given time.

Particular aspects of the subject matter described in this disclosure can be implemented to realize one or more of the following potential advantages. In some examples, by prioritizing positioning sessions, the described techniques can be used to make more efficient use of bandwidth and power usage among devices participating in a UWB positioning session. Moreover, by using a server to perform the prioritization for multiple UWB devices, these advantages can be realized among a larger set of UWB devices (e.g., a cluster or network of UWB devices). These and other advantages will be apparent to a person of ordinary skill in the art in view of the embodiments described herein. Embodiments are described below, following a review of applicable technology.

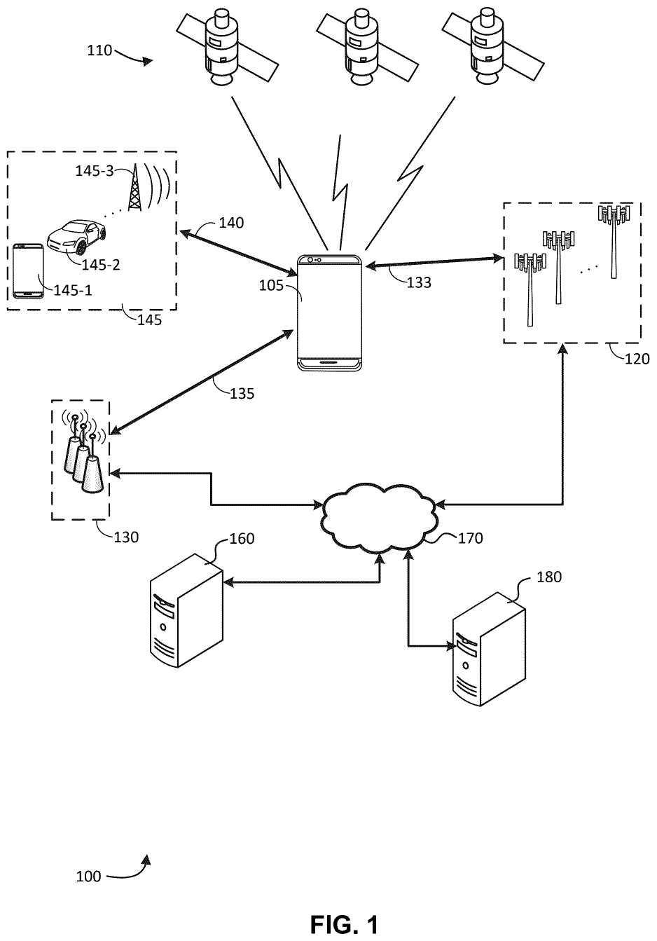

Although UWB-based positioning may be used in an ad hoc manner as a standalone positioning technique between electronic devices capable of UWB positioning (also referred to herein as “UWB devices”), in some embodiments UWB-based positioning may be used as one of many techniques for positioning an electronic device in a positioning system. FIG. 1 provides an example of such a positioning system.

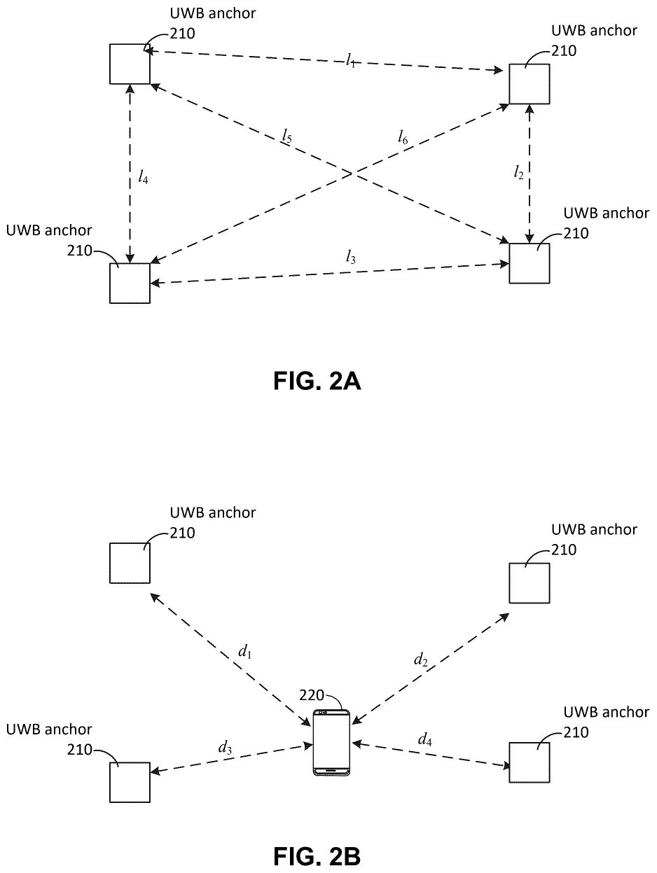

FIG. 1 is a simplified illustration of a positioning system 100 in which a mobile device 105, location server 160, and/or other components of the positioning system 100 can use the techniques provided herein for UWB-based positioning for a mobile device 105, according to an embodiment. The techniques described herein may be implemented by one or more components of the positioning system 100. The positioning system 100 can include: a mobile device 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the positioning system 100 can estimate a location of the mobile device 105 based on RF signals received by and/or sent from the mobile device 105 and known locations of other components (e.g., GNSS satellites 110, base stations 120, APs 130) transmitting and/or receiving the RF signals. Additional details regarding ranging and particular location estimation techniques are discussed in more detail with regard to FIGS. 2A and 2B.

It should be noted that FIG. 1 provides only a generalized illustration of various components, any or all of which may be utilized as appropriate, and each of which may be duplicated as necessary. Specifically, although only one mobile device 105 is illustrated, it will be understood that many mobile devices (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network. A mobile device of a cellular network (e.g., LTE and/or NR) also may be referred to as a User Equipment (UE).

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view of Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location server 160, by accessing the network 170 via a base station 120 using a first communication link 133. Additionally or alternatively, because APs 130 also may be communicatively coupled with the network 170, mobile device 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of mobile device 105 and/or provide data (e.g., “assistance data”) to mobile device 105 to facilitate location measurement and/or location determination by mobile device 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of mobile device 105 using a control plane (CP) location solution for LTE radio access by mobile device 105. The location server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning system 100 (e.g., GNSS satellites 110, APs 130, base stations 120). The estimated location of the mobile device 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), UWB, IEEE 802.15x, or a combination thereof. Mobile devices 145 may additionally or alternatively use non-RF wireless signals for positioning of the mobile device 105, such as infrared signals or other optical technologies.

Mobile devices 145 may comprise UEs communicatively coupled with a cellular or other mobile network (e.g., network 170). When one or more other mobile devices 145 comprising UEs are used in the position determination of a particular mobile device 105, the mobile device 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards. As described hereafter, UWB may be one such technology by which the positioning of a target device (e.g., mobile device 105) may be facilitated using measurements from one or more anchor devices (e.g., mobile devices 145). Measurements of distance between the target device and one or more anchor devices may be referred to herein as “ranging.”

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

As noted, positioning of the mobile device 105 may be facilitated by a location server 160, which may be part of a cellular network. Additionally or alternatively, the location server 160 may be capable of facilitating other types of network-based positioning, including positioning using APs 130 (e.g., Wi-Fi positioning) and/or mobile devices 145 (e.g., Bluetooth positioning, UWB positioning, etc.). To do so, the location server 160 may communicate with one or more devices (e.g., a target device such as the mobile device 105 and/or one or more anchor devices), coordinate positioning sessions with the one or more devices, provide assistance data for positioning-related measurements and/or calculations, receive measurement data from one or more devices for determining a position of a target device, provide synchronization-related data, or perform a combination these tasks, for example. According to some embodiments, the location server 160 may support various procedures/methods such as Assisted GNSS (A-GNSS), Time Difference Of Arrival (TDoA) (which also may be referred to as Observed Time Difference Of Arrival (OTDoA)), Real Time Kinematic (RTK), Precise Point Positioning (PPP), Differential GNSS (DGNSS), Enhance Cell ID (ECID), angle of arrival (AoA), angle of departure (AoD), WLAN positioning, RTT, multi-cell RTT, two-way ranging (TWR) (e.g., including single-sided TWR (SS-TWR) and/or double-sided TWR (DS-TWR)), and/or other positioning procedures and methods. The location server 160 may process location service requests for the mobile device 105 and/or third parties (e.g., a device communicatively coupled with the location server 160 and authorized to receive a position of the mobile device 105).

To support various positioning procedures/methods, the mobile device 105 and/or one or more anchor devices may be capable of performing any of a variety of measurements and/or procedures. This can include, for example, Received Signal Strength Indicator (RSSI), RTT, Reference Signal Received Power (RSRP), Reference Signal Received Quality (RSRQ), Reference Signal Time Difference (RSTD), Time of Arrival (ToA), AoA, Receive Time-Transmission Time Difference (Rx-Tx), Differential AoA (DAOA), AoD, or Timing Advance (TA).

In some embodiments, TDoA assistance data may be provided to a mobile device 105 by the location server 160 for a reference signal and one or more response or neighbor signals, relative to the reference signal. For example, the assistance data may provide timing, frequency, and/or other parameters of the reference and response/neighbor signals to allow a device (e.g., a target and/or anchor) to perform ToA and/or RSTD measurements for TDoA positioning. Using the RSTD measurements, the known absolute or relative transmission timing of each cell, and the known position(s) of wireless node physical transmitting antennas (e.g., anchors) for the reference and response/neighbor signals, the UE position may be calculated (e.g., by the mobile device 105 or by the location server 160). More particularly, the RSTD for a neighbor signal “k” relative to a reference signal “Ref,” may be given as (ToAₖ-ToA_{Ref}). ToA measurements for different signals may then be converted to RSTD measurements and sent to the location server 160 by the mobile device 105. Using (i) the RSTD measurements, (ii) the known absolute or relative transmission timing of each cell, (iii) the known position(s) of physical transmitting antennas that transmit the reference and response/neighbor signals, and/or (iv) directional characteristics of the signals such as a direction of transmission, the mobile device 105 position may be determined.

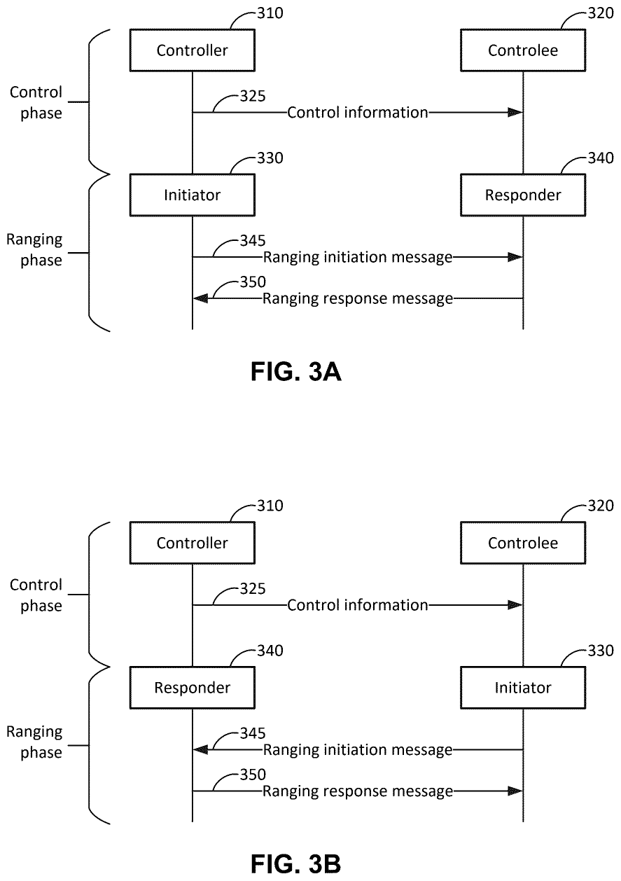

With regard to UWB-based positioning, UWB devices may conduct “sessions” during which the devices engage in direct communications (e.g., D2D communications) to coordinate the exchange of ranging frames from which ToA may be determined. Further, different types of measurements may be performed during these sessions to conduct the UWB-based position. FIGS. 2A and 2B, discussed below, provide examples of what types of measurements may be performed. And FIGS. 3A-3B, also discussed below, provide additional details regarding UWB-positioning sessions.

UWB devices may vary in form and function. As indicated in FIG. 1, a UWB device may comprise a mobile device such as a mobile phone with UWB functionality. Similarly, UWB devices may comprise other personal electronics, such as laptops, tablets, personal media players, or the like. Further, as noted, UWB devices may comprise vehicles, drones, robots, or other mobile devices that may move autonomously, and may be used in consumer, industrial, military, and/or other applications. UWB devices may also comprise tracking devices used in logistical applications to track packages, shipping containers, or the like. Additionally or alternatively, UWB devices (such as UWB anchors, described hereafter) may comprise proprietary and/or dedicated RF beacons deployed at known locations for monitoring the location of tags or devices used in logistical applications and/or tracking applications (e.g., in a factory, warehouse, hospital, etc.). UWB devices may be used in proximity applications to, for example, unlock the door as a user (e.g., an authorized user) approaches. UWB devices may also be used in other applications and/or device types. Some UWB devices may also be deployed in a factory setting to monitor robots, assembled parts, or the like.

It can also be noted that, although embodiments described herein are generally described with respect to providing positioning for a UWB device, embodiments are not so limited. UWB sessions additionally or alternatively may be conducted to perform RF sensing of objects. RF sensing, which is a technique for using reflections of RF signals from objects to detect the objects, may be performed using a monostatic configuration (e.g., a single device both transmitting and receiving the RF signals), bistatic configuration (a single transmitter and a single receiver), or multistatic configuration (one or more translators and one or more receivers). Depending on desired functionality, one or more UWB sessions may be conducted to support any of these RF sensing configurations.

FIGS. 2A and 2B are simplified diagrams illustrating how UWB positioning may be performed in a network of UWB anchors 210. As noted, anchor devices (referred to herein as “anchors” or “UWB anchors”) may comprise UWB devices with known locations that can be used to determine the position of a target 220, or “tag,” using UWB RF signals. UWB positioning may be performed utilizing relevant standards (e.g., IEEE 802.15.4ab), which enable high-accuracy, low power positioning. One or more of the UWB anchors 210 and/or UWB target 220 may be connected with a network, such as in the manner illustrated in the positioning system 100 of FIG. 1. In some embodiments, the UWB anchors 210 and/or UWB target 220 may form an ad-hoc network, which may or may not be connected with a network (e.g., in the manner shown in FIG. 1). Further, the UWB anchors 210 and/or UWB target 220 may comprise any of a variety of device types, as previously indicated.

If the position of one or more UWB anchors 210 is not yet known, such as in an ad-hoc network, an initial provisioning of the UWB anchors 210 may be performed. In the provisioning, UWB anchors 210 may perform ranging measurements to determine relative distances (11-16) between UWB devices 210, as illustrated in FIG. 2A. This can enable the UWB anchors 210 to determine the relative locations with one another and, if the absolute location of any UWB anchor 210 is known, the absolute locations (e.g., with respect to a coordinates system). Once the positions of the UWB anchors 210 is known, the determination of location of a target 220 can be made by determining the distances (d1-d6) between the UWB anchors 210 and target 220. These distances can be determined using a variety of positioning-related measurements and/or procedures. This can include, for example, RSTD, ToA, two-way ranging (TWR) (e.g., including single-sided TWR (SS-TWR) and/or double-sided TWR (DS-TWR)), TDoA, and more. Additionally or alternatively, angle-based measurements may be made for positioning of the target 220, including angle of arrival (AoA) and/or Angle of departure (AoD).

As noted group of UWB anchors 210 may conduct sessions in which UWB anchors 210 perform a series of operations to determine the position of one or more of the devices, and during which the UWB anchors 210 engage in direct communications (e.g., D2D communications) to coordinate the exchange of data, synchronize (e.g., for TDoA positioning). A group of UWB anchors 210 may be called a “cluster,” and a network of UWB devices may comprise multiple clusters. Each cluster may include any number of UWB anchors 210, and different clusters may overlap, such that one or more UWB anchors 210 may be a part of one or more different clusters.

FIG. 3A is a flow diagram illustrating the roles different devices may assume with regard to a UWB ranging session (or simply a “UWB session”), which may be conducted in accordance with a relevant UWB positioning standard (e.g., IEEE 802.15.4ab). Here, each UWB device may be referred to as an enhanced ranging device (ERDEV). ERDEVs may be referred to different terminologies (e.g. initiator/responder or controller/controlee) at different layers of the network stack. The terms initiator and responder (described hereafter) would be used at lower layers (e.g., at UWB physical (PHY) and media access control (MAC) layers), while the terms controller and controlee (also described hereafter) may be used at higher layers (e.g., an application layer of the ERDEVs).

As indicated, for a pair of ERDEVs communicating with each other, the controller 310 is an ERDEV that sends control information 325 to a receiving ERDEV, designated as the controlee 320. The control information 325 may include parameters for the UWB ranging session, such as timing, channel, etc. Although not illustrated, the controlee 320 can send acknowledgment to the control information 325, may negotiate changes to the parameters, and/or the like.

The exchange between controller 310 and controlee 320, including the sending of the control information 325 and subsequent related exchanges between controller 310 and controlee 320 regarding control information, may be conducted out of band (OOB) using a different wireless communication technology (e.g., Bluetooth or Wi-Fi), prior to a ranging phase. Put differently, a UWB session may be associated with a control phase and a ranging phase, where the control phase (which may take place on an OOB link) comprises a preliminary exchange between controller 310 and controlee 320 of parameter values for the ranging phase, and the subsequent ranging phase comprises the portion of the UWB session in which devices exchange messages within the UWB band for ranging measurements. (It can be noted, however, that some control information may be exchanged within the UWB band (e.g., a “ranging control phase” occurring in the first slot of a UWB round). Accordingly, some aspects of the control phase may be considered to occur in band, subsequent to the preliminary OOB exchange between the controller 310 and controlee 320.)

The UWB session may occur afterward, in accordance with the parameters provided in the control information. In the ranging phase of the UWB session, one ERDEV may take the role of an initiator 330 and the other ERDEV may take the role of a responder 340. As indicated in FIG. 3A, the initiator 330 may initiate UWB ranging by sending a ranging initiation message 345 to the responder 340, to which the responder 340 may reply with a ranging response message 350, and timing measurements may be made of these messages (by the devices receiving the messages) to perform two-way ranging (TWR). Depending on the parameters of the control information 325, additional exchanges may be made in the ranging phase between the initiator 330 and responder 340 to allow for additional ranging measurements.

The roles of initiator 330 and responder 340 may be indicated in the control information 325. Further, as indicated in FIG. 3A, the controller 310 in the control phase may be the initiator 330 in the ranging phase of the UWB session. Alternatively, as indicated in FIG. 3B, the controller 310 in the control phase may be the responder 340 in the ranging phase. The determination of which device is initiator 330 and which is responder 340 may depend on the parameters set forth in the control information 325, in which case the controlee 320 correspondingly becomes either the responder 340 or the initiator 330. According to some embodiments, a controller/initiator may conduct ranging with multiple controlees/responders.

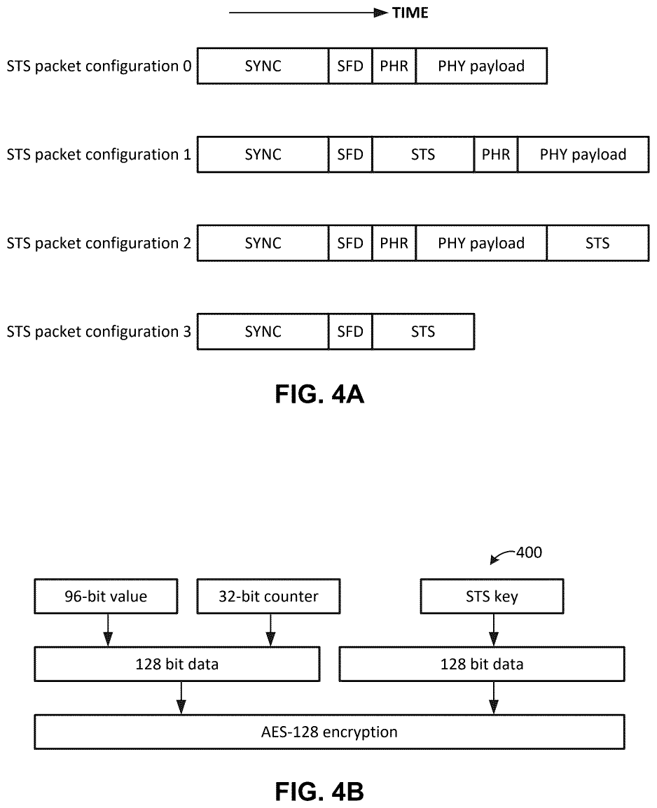

FIG. 4A is an illustration of different packet configurations that can be used in a UWB session (e.g., for sensing and/or positioning) at the UWB PHY layer, which may be used in some embodiments (e.g., in ranging initiation and/or response messages, as shown in FIGS. 3A and 3B above). These packet configurations may be defined and/or used in relevant UWB standards (e.g., IEEE 802.15.4z). As shown, ranging functionality may be based on channel estimation using the SYNC preamble, included in each of the for possible configurations (e.g., configurations 0-3) used in current configurations. (Configuration 0 is currently used as a default configuration.) The SYNC preamble may comprise a bit sequence (such as a Ipatov ternary sequence, Gold sequence, Golay sequence, polyphase sequence like Zadoff-Chu sequence, etc.) that exhibits good autocorrelation properties (e.g., sufficient for ranging/sensing measurements). As illustrated, the different packet configurations may also include a start of frame delimiter (SFD) to help demarcated the SYNC preamble from the rest of the packet, a PHY payload for conveying data (e.g., for communication, time stamp information, etc.), and/or a scrambled timestamp sequence (STS). The STS is a security feature with a unique sequence known to transmitter and receiver, which can authenticate the data packet source and help prevent over-the-air attacks that can falsify a ToA estimate for ranging/sensing in a UWB session. This aspect of UWB ranging/sensing is described in more detail with regard to FIG. 4B.

FIG. 4B is an illustration of a deterministic random bit generator (DRBG) 400 that can be used to generate an STS, which may be used in some embodiments (e.g., to generate the STS as shown in FIG. 4A). Here, the DRBG 400 is based on Advanced Encryption Standard (AES)-128 in counter mode. As illustrated, the DRBG 400 uses a 96-bit value, a 32-bit counter, and an STS key. The STS key may be exchanged securely between ERDEVs (e.g., an initiator and one or more responders) prior to the UWB session. For example, an STS key may be provided by the controller (e.g., controller 310 of FIG. 3A or 3B), for example, at the application layer over a secure link (e.g., an OOB link). DRBG bits {0,1} may be mapped to {+1,−1} and spread. This can result in a ternary sequence of {−1,0,+1} chips. The ternary sequences may then be grouped (e.g., group of 32) to form an active STS segment.

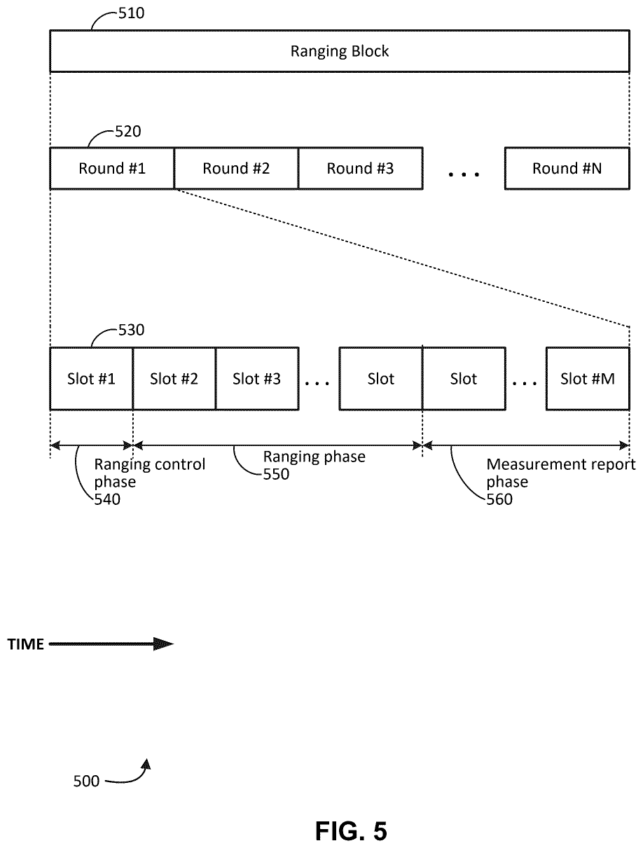

FIG. 5 is a diagram 500 illustrating how time may be segmented and utilized within a UWB positioning session, which may be used in some embodiments. A UWB session may occur over a period of time divided into sub-portions according to a hierarchical structure. This timing comprises one or more consecutive ranging blocks 510, which may have a configurable duration (e.g., 200 ms). (For simplicity, only one ranging block 510 is shown in FIG. 5. However, a UWB session may utilize multiple blocks, which may occur in succession. Also, although called “ranging” blocks 510, they may be used for ranging and/or sensing.) Each ranging block 510 may be split into one or more successive rounds 520 (e.g., N rounds). The number and length of the rounds may be configurable. The rounds 520 may be further split into different slots 530, which also may have a configurable number and length (e.g., 1-2 ms). According to some embodiments, multiple rounds may be used for interference handling. For example a given responder may transmit a message within only a single round per block, and the round index may either be statistically configured by the controller or selected per a hopping pattern.

The slots within a round 520 may be allocated for different purposes. For example, the initial slot may be dedicated as the ranging control phase 540, in which an initiator UWB device (e.g., an initiator anchor), transmits control information for the other UWB devices participating in a UWB session (e.g., responder anchors and/or other UWB devices). This information can include, for example, an allocation of slots among the different responder devices. During the subsequent ranging phase 550, the different responder may transmit in accordance with the allocated slot. That is, each responder may be allocated a corresponding slot in the ranging phase 550 to transmit one or more ranging/sensing signals. The ranging phase 550 may be followed by a measurement report phase 560 in which UWB anchors in a cluster may report measurements (e.g., of signals measured during the ranging phase 550). The structure of the initiation and/or response messages may use the PHY format previously described with respect to FIG. 4A.

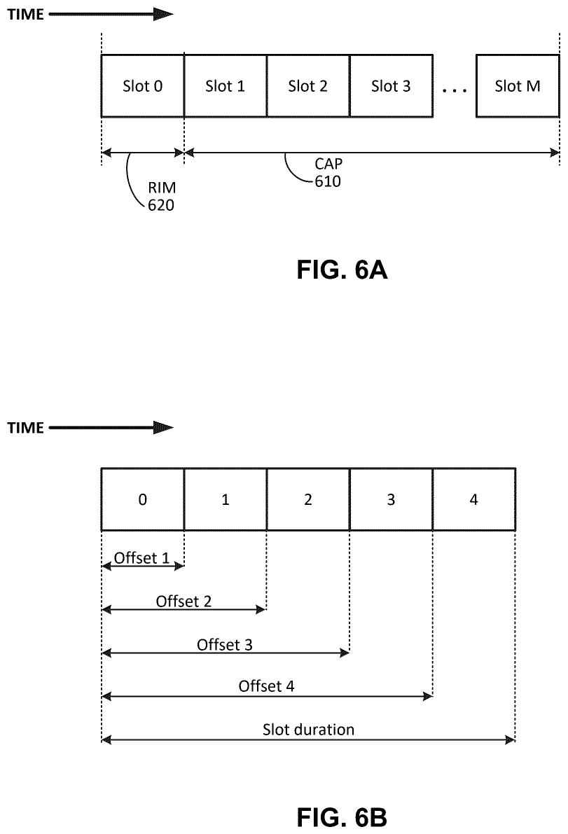

FIGS. 6A and 6B are timing diagrams illustrating how contention-based ranging using a Contention Access Period (CAP) 610 may be implemented, according to some embodiments. The CAP 610 may be preceded by a ranging initiation message (RIM) 620 (e.g., sent by the initiator). Contention-based ranging may be used, for example, when the controller does not know about the devices that will participate in the UWB Session. In such instances, the controller may always assume the role of the initiator and the controlees (e.g., one or more responding devices that will participate in the session) may always assume the role of the responders. To allow multiple controlee/responders to participate in the UWB session, the controller may advertise a CAP 610, which comprises a portion of slots within the ranging round. (Contents of the message advertising the CAP 610 may include parameters that may be chosen by the controller/initiator.) Essentially, the CAP 610 indicates slots within the round in which a controlee/responder may communicate to participate in the UWB session.

Devices that receive the message advertising the CAP 610 (e.g., potential controlees/responders) may respond based on, for example, rules implemented by the devices for participating in such ranging sessions. In particular, any controlee/responder that wants to participate in the UWB session a randomly select a slot of the CAP (e.g., which may be designated as slots 1 to M in each round, as indicated in FIG. 6A) and transmit a ranging message during the selected slot. Thus, the fewer controlee/responder responses and/or the larger the value for M, the less likely collisions are to occur.

According to some embodiments, each controlee/responder may also transmit after a random time offset within a slot. FIG. 6B illustrates example offsets for a slot. The allowable values for such a time offset are also contained within the control message. Once the controller has determined the identity of devices (e.g., using a responder management list-RML) after a contention-based round, it can reserve some of the slots for those devices that were able to send a message in the preceding round. The remaining slots in the CAP 610 (up to M) may continue to serve as slots that can be randomly selected by other unknown devices. Thus, for a controlee/responder, access to the UWB session may be random access until the controlee/responder is recognized by the controller/initiator and included on the RML, after which the controlee/responder is given a dedicated slot for communication.

According to some embodiments, “hybrid-based ranging” may be utilized in UWB, in which rounds include a combination of scheduled and unscheduled slots. In hybrid-based ranging, a round may comprise at least one CAP and at least one contention free period (CFP) to accommodate both known controlees and unknown controlees. Again, the controller can broadcast the reserved slots of the CAP to allow unknown controlee/responders to respond (e.g., by selecting a random slot in the CAP in which to send a response message). Additionally, controlees that are known to the controller may be given a dedicated slot (e.g., in the configuration parameters broadcast by the controller) within the CFP in which to respond. A round may have multiple CAPs and/or multiple CFPs (also called CAP and CFP “phases”), depending on desired functionality. The first slot (slot 0) in each round may be reserved for in-band control information from the controller/initiator. Further, the first slot of each of the CAP and CFP phases may be reserved for control messages that determine the scheduling of the slots within the respective phase.

Downlink (DL) TDoA (DL-TDoA) measurements in UWB may be performed in accordance with one or more of the UE techniques described above (e.g., with respect to scheduling, contention, etc.) to perform positioning of a UWB device in a configuration such as the configuration illustrated in FIG. 2B. The DL-TDoA measurements in UWB may be in accordance with the standards set forth by FiRa™, the standards organization comprising a consortium of multiple member entities developing standards for UWB ranging and positioning. In DL-TDoA (DT) positioning, a DL-TDoA Anchor (also referred to herein simply as an “anchor”) may transmit a DL-TDoA Message (DTM) that can be used by tags (e.g., a mobile device or target device for which positioning or ranging is to be performed) to perform localization based on DL-TDoA. The tag may then measure the reception times of every DTM that it receives from a cluster of DL-TDoA Anchors, and utilize the reception timestamp along with the obtained coordinates of the DL-TDoA Anchors to estimate its position. According to some embodiments, the DTM messages also may be used for synchronization between the anchors. A final DTM message may be optional. Note that only the DT-Anchors exchange messages, and the tags passively listen and receive packets.

In this context, a cluster is a set of DT-Anchors that exchange DTMs with each other to provide a localization service to tags. The cluster may consist of one Initiator DT-Anchor (or “Init-anchor”) and one or more Responder DT-Anchors (or “RESP Anchors”). According to some embodiments, a Bluetooth (and/or other wireless) advertiser broadcasts OOB configuration messages and creates a cluster of anchors within coverage area. To perform DL-TDoA positioning anchors in a cluster may transmit DTMs during different rounds of a positioning session, following the timing structure of a UWB positioning session as previously described with respect to FIG. 4. In each round, the transmission of the DTMs may comprise a poll DTM transmitted by the Init-anchor (e.g., in an initial slot of the respective round), followed by response DTMs transmitted by different Resp-anchors during different subsequent slots of the round. Optionally, there may be a final DTM message, again transmitted by the Init-anchor. Again, using the differential timing at which these messages are received by the tag, the location of the tag with respect to the anchors can be determined.

Similarly, uplink (UL) TDoA (UL-TDoA) may be performed by UWB devices. Generally speaking, the process used for UL-TDoA may be similar to the previously described process of DL-TDoA, in many aspects. However, in contrast to DL-TDoA in which the tag may remain passive (without the need to transmit any messages), the tag in UL-TDoA may transmit one or more UL messages in UL-TDoA, which are received by various anchors of a cluster. In particular, a tag transmits messages, called “blink” messages, in order to be located by the anchor infrastructure.

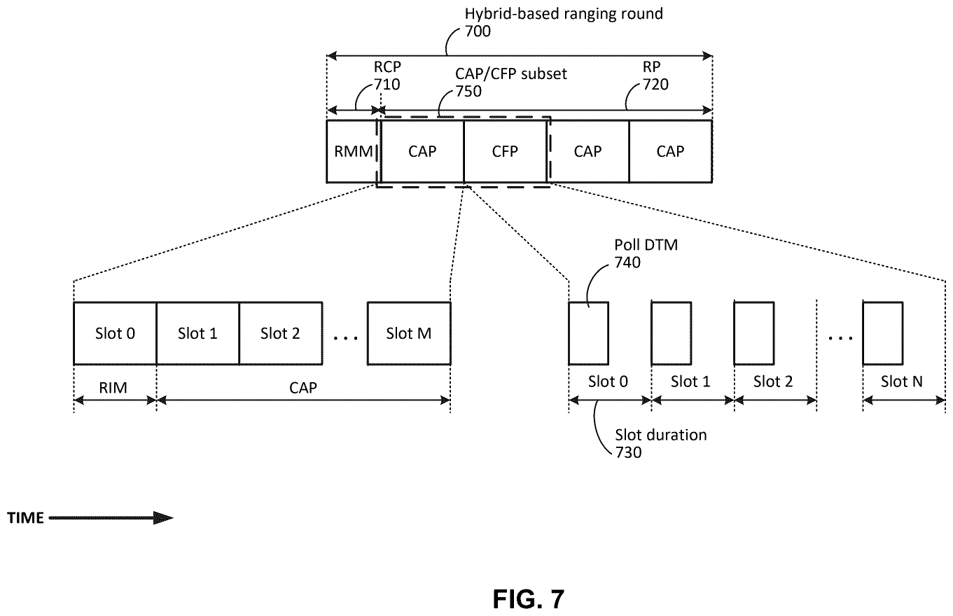

FIG. 7 is a timing diagram of a hybrid-based ranging round 700, provided detailed illustrate how embodiments may implement a process for moving a UWB tag from a CAP to a CFP. As previously noted, a hybrid-based ranging round 700 includes one or more CAP and CFP portions. Specifically, the hybrid-based ranging round 700 may comprise a ranging control phase (RCP) 710 (in which a ranging management message (RMM) may be transmitted by the initiator), followed by a ranging phase (RP) 720 comprising one or more CAPs and one or more CFPs. (The RP 720 in FIG. 7 has two CAPs and to CFPs, but numbers may vary. A pair of CAP/CFPs may be referred to as a CAP/CFP subset 750. A hybrid-based ranging round 700 may have one or more CAP/CFP subsets 750.) According to embodiments, the CAP may be used for unknown tags that will potentially send blink messages (e.g., as described above with respect to FIG. 6A/6B), while the CFP (comprising a series of slots having slot duration 730 in which transmissions may be made, where a first slot may comprise a poll DTM 740) may be used for scheduled transmissions comprising synchronization between anchors for DL-TDoA and/or UL transmissions by known tags for UL-TDOA.

Parameters for a given UWB session may vary, depending on desired functionality. Further, they may be provided by the controller to one or more controlees (e.g., during a control phase, as described with respect to FIGS. 3A and 3B) in an OOB message sent by a controller (e.g., using an application layer packet) for contention-based and/or hybrid-based ranging. In particular, these may be included in a broadcast message as previously described (e.g., broadcasting information regarding one or more CAPs and/or CFPs). According to some embodiments, a controlee/responder may respond to such a message by indicating its capabilities for a UWB session. If the controlee/responder has a limitation with respect to a particular parameter (e.g., it may only be able to use a certain channel or subset of channels for UWB ranging), the controller/initiator may accommodate the limitation of the controlee/responder. Relevant parameters may include, for example, a ranging method (e.g., one-way ranging (OWR), SS-TWR, DS-TWR), multi-node mode (e.g., one-to-one or one-to-many), ToF and/or AoA report, STS configuration (e.g., static or dynamic), blocks striding (e.g., whether blocks can be skipped), block/round/slot duration, channel number, CAP size range (e.g., minimum and maximum values of a CAP size), number of controlees, supported ranging message formats (e.g., SP0-SP3), clock drift (e.g., whether it is within 25 ppm or not), a maximum number of retries allowed, session initiation time until a first UWB packet is sent, pulse repetition frequency (PRF) mode (e.g., base PRF (BPRF) or high PRF (HPRF)), key rotation, or the like. As noted hereafter, these parameters may be used for UWB session selection, according to some embodiments.

In view of the properties of UWB sessions described above, a given UE may be able to participate in a plurality of UWB sessions. However, participating in all possible UWB sessions may not be practical or efficient. To address these and other issues, embodiments herein provide techniques by which a device can prioritize which UWB sessions to participate in using relevant decision metrics.

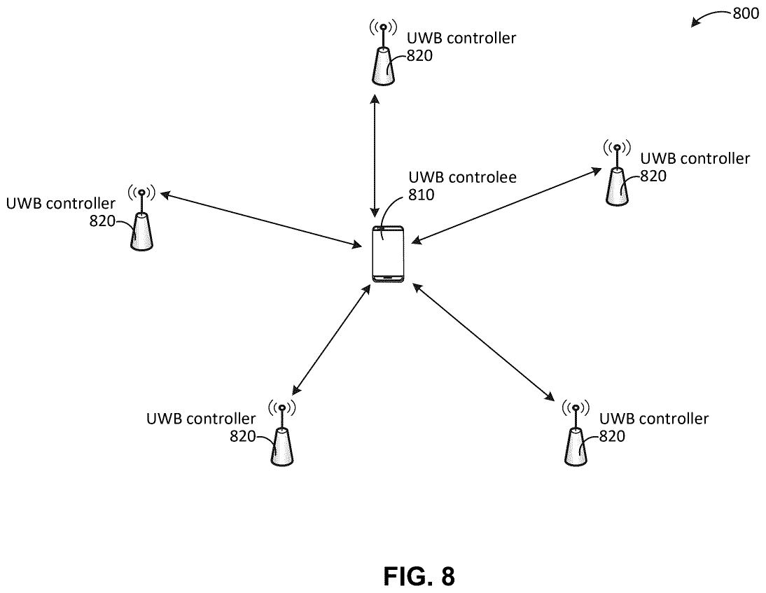

FIG. 8 is a diagram illustrating an example scenario 800 in which a UWB device may utilize embodiments described herein for UWB positioning session prioritization. In the scenario 800, a UWB controlee 810 receives multiple broadcast messages from multiple other UWB controllers 820 for setting up UWB sessions. The UWB controllers 820 may comprise anchors (e.g., UWB devices at fixed locations or mobile UWB devices at known locations), or other types of UWB broadcasting configuration messages. In this example, UWB controlee 810 is unknown to all the UWB controllers 820 (e.g., does not have a reserved slot in a CFP for UWB controllers 820) and wants to transmit ranging messages during the CAP of the candidate UWB sessions. Under current applicable standards, default UWB behavior may allow a UWB controlee to participate in all UWB sessions. However, with no governing rule or reasoning for participating in UWB sessions, this may result in an inefficient use of available UWB bandwidth, among other things.

Embodiments herein provide for a prioritization by a UWB device (e.g., UWB controlee 810) of UWB sessions in which to participate by using relevant decision metrics, such as the parameters described above. For example, a controlee UWB may prioritize a UWB session based on the channel number advertised by a controller UWB. In the scenario 800, for instance, UWB controlee 810 may maintain a list of channels that have been busy or frequently occupied. According to some embodiments, this may also include channel occupation by technologies other than UWB. (UWB shares some wireless frequencies with Wi-Fi and 5G NR, and thus channel occupation these other wireless technologies may impact a UWB session). This list may be maintained over a certain time window (e.g., a predetermined length of time). UWB controlee 810 can then prioritize sessions with one or more of the UWB controllers 820 in which the channel would not cause interference with other ongoing sessions/technologies. That is, UWB controlee 810 may prioritize sessions that use relatively unoccupied channels over sessions that use busier channels.

As another example, a controlee UWB device may prioritize a UWB session based on location information of a controller UWB device. In scenario 800, for instance, UWB controlee 810 may prioritize sessions with UWB controllers 820 that can serve as an anchor node and provide its location information for frame of reference. This type of functionality can be particularly relevant in applications such as asset tracking, for example. It can be noted that UWB devices at known, fixed locations may be capable of serving as anchors at any time, and mobile UWB devices also may be capable of serving as anchors for a period of time during which their position is known within a degree of accuracy (e.g., if their position has been determined, and they are currently immobile for their motion is being tracked).

As another example, a controlee UWB device may prioritize a UWB session based on an ability to communicate a particular configuration format (e.g., as previously described with respect to FIG. 4A), including customized configurations. In scenario 800, for instance, UWB controlee 810 may prioritize sessions with UWB controllers 820 that allow a custom configuration where only a preamble or STS is transmitted, which may be desirable in certain circumstances.

As previously noted, UWB sessions may include a wide variety of applicable parameters. As such, in addition or as an alternative to one or more of the parameters discussed above, a controlee UWB may prioritize a UWB session based on one or more of the following:
Received Signal Strength (RSS) of the received broadcast message: a controlee UWB device may prioritize a UWB session based on sessions that can provide greater SNR for more accurate position estimates. Here, RSS/SNR may not be included in a configuration message received by the controlee UWB but may be determined (e.g. measured) from the message.
Slot/Round/Block duration: a controlee UWB device may prioritize a UWB session based on slot/round/block duration of sessions, which (as previously noted) may be unique to each session. For example, a controlee UWB device may prioritize a UWB session that can help the controlee UWB attain a position estimate with relatively low latency (e.g., as compared with other UWB sessions).
Block striding: block striding is a feature in UWB that allows a session to skip one or more blocks to help conserve power. Thus, a controlee UWB device may prioritize a UWB session based on sessions that allow larger number of blocks to be skipped for power saving, if power savings is a priority of the controlee UWB device. Certain battery-powered devices, for example, may prioritize UWB sessions based on block striding.
STS configuration and key rotation: if security is a priority to a controlee UWB device, the controlee UWB device may prioritize a UWB sessions that give higher importance to enabling secure ranging functionality. Here, “key rotation” may refer to an AES-128 encryption key used to encrypt data. Sessions with frequently rotated keys may be more secure than those with a less-frequent key rotation. And thus, a controlee UWB device may prioritize sessions with a higher key rotation rate.
CAP size range: a controlee UWB device may prioritize a UWB session based on CAP size. That is, sessions having larger CAP size ranges may be prioritized over those with smaller CAP size ranges to minimize contention/collision probability.
Number of controlees: a controlee UWB device may prioritize a UWB session based on how many controlees a session is capable of handling. That is, a controlee UWB device may prioritize sessions having a larger number of allowable controlees, which can help to minimize contention/collision probability. Additionally or alternatively, a current number of controlees (e.g., in the CAP and/or CFP) could also be communicated to controlees, thereby enabling controlee is to prioritize UWB sessions having multiple available slots for controlees (e.g., UWB sessions having the largest number of slots available as determined by the difference between session capacity and slots taken). This can be done, according to some embodiments, by the controller providing a number of allowable controlees in each of the CAP and CFP.
Clock drift: a controlee UWB device may prioritize a UWB session based on the stability of the clock. That is, if high accuracy is important (e.g., as determined based on an application-layer request with an accuracy requirement), a controlee UWB may prioritize UWB sessions with controller UWB's having a more stable clock source for better accuracy.
UWB Initiation Time: the UWB initiation time specifies a time period after which the first initiation message will be sent. In other words, this defines the duration in time between the OOB message sent by the controller (e.g., ranging control message) and UWB initiation message. This allows receiving UWB devices (potential controlees) to prepare for the UWB session (e.g., tuning RF chains, etc.). Because each controlee UWB device may have a different initiation time, each UWB device may prioritize UWB sessions that are compatible with its initiation time. For example, if a controlee UWB device has a short initiation time, it may prioritize you doubly be sessions having smaller initiation times in the interest of latency.

According to some embodiments a server, referred to herein as a Connected Intelligent Edge (CIE), can be used to further coordinate UWB sessions between one or more controller UWB devices and one or more controlee UWB devices. According to some embodiments, the CIE may be privately managed, and/or may be a cloud-based service accessible to UWB devices. According to some embodiments, the CIE may correspond with the location server 160 of FIG. 1. The functionality of the CIE additionally or alternatively may be executed by a physical or virtual server that also provides location functionality to other networks (e.g., a cellular network and/or other UWB networks/clusters). According to some embodiments, the CIE, and/or one or more functions described herein pertaining to the CIE, may be executed by a location management function (LMF) server of a 5G network. In some implementations, the functionality provided by the CIE may be provided on a subscription-based basis.

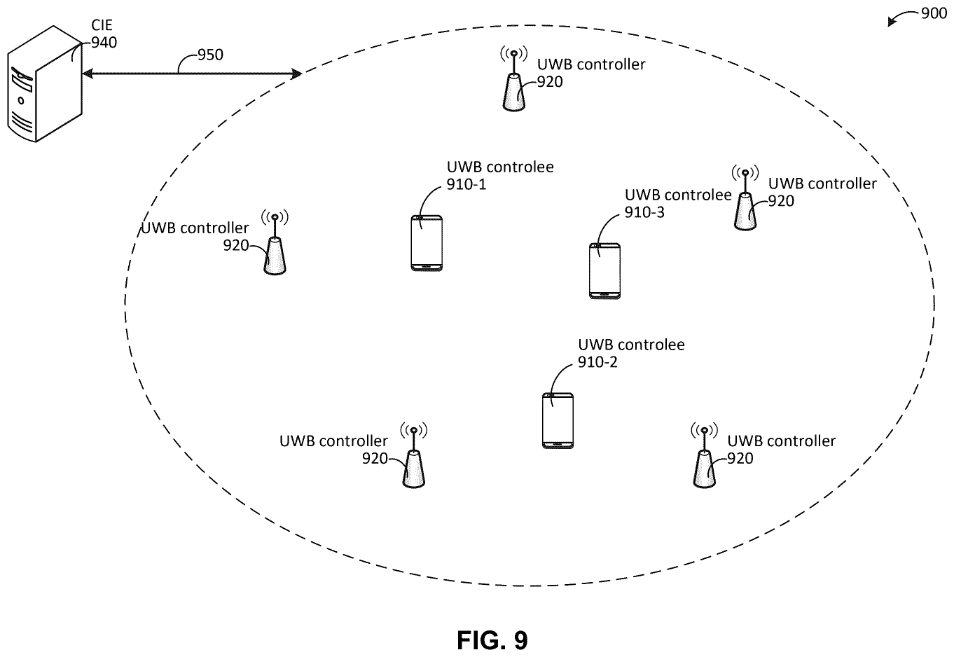

FIG. 9 is a diagram of another example scenario 900 in which a CIE and UWB devices may utilize embodiments described herein for UWB positioning session prioritization. The scenario 900 is generally similar to the scenario 800 of FIG. 8. However, in contrast to the scenario 800, the scenario 900 includes three UWB controlees 910 (a first UWB controlee 910-1, a second UWB controlee 910-2, and a third UWB controlee 910-3), as well as a CIE 940 that is communicatively coupled with the UWB controlees 910 and (optionally) UWB controllers 920 via a connection 950. The connection 950 may represent one or more wireless technologies (e.g., Wi-Fi, cellular, etc.), intermediary devices, communication networks (e.g., public/private networks, the Internet, etc.), etc., enabling communication between the CIE 940 and the UWB controlees 910 and (optionally) UWB controllers 920. (In some embodiments, the CIE 940 may not be communicatively coupled with the UWB controllers 920. For example, UWB controllers 920 may be standalone anchors with which UWB controlees 910 may conduct UWB sessions.) The use of the CIE 940 (or equivalent) can allow for centralized decision-making when it comes to UWB session prioritization. That is, the CIE 940 may perform prioritization using the considerations previously described with respect to FIGS. 8 and 9. However, because it is in communication with multiple UWB devices (e.g., UWB controlees 910), the use of the CIE 940 may provide for additional efficiency over device-based prioritization determinations (e.g., as in the scenario 800 of FIG. 8). In the scenario 900 and other configurations utilizing a CIE 940, UWB controlees 910 may report relevant information to the CIE 940, such as the controller parameters that are being advertised by each of the UWB controllers 920 (e.g., in broadcast control information, as previously described). In turn, the CIE 940 can then form a mapping between the UWB controlees 910 and UWB controllers 920, and report back to the UWB controlees 910 with detailed information regarding which session to choose, and (optionally) which slot to pick within each session, or which group of slots to randomly select a slot from. This can allow the CIE 940 to help distribute UWB ranging for the various UWB controlees 910 among the UWB controllers 920 more evenly (and/or load balance in view of capabilities of the UWB controllers 920), help manage/minimize collisions, and/or help make efficient use of processing, bandwidth, and/or other resources in other ways.

In particular, RF collisions may be reduced through the use of a CIE via any of a variety of techniques, which may be implemented in the embodiments herein. For example, RF collisions may be reduced by (i) enabling each UWB controlee to choose a random slot from a different group of slots than other UWB devices; (ii) enabling each UWB controlee to choose different channels that may overlap in time; (iii) if the CIE comprises or is communicatively coupled with a location server in a cellular network, it may help reduce RF interference during the UWB sessions by enabling UWB devices to choose slots that do not overlap in time/frequency with cellular positioning signals (e.g., Positioning Reference Signals (PRS)); (iv) if the CIE comprises or is communicatively coupled with a privately managed server that configures enterprise Wi-Fi or crowdsources measurements, then it may enable UWB devices to choose sessions that do not overlap in frequency with the Wi-Fi Basic Service Sets (BSSs)/crowdsourced measurements; or any combination of (i)-(iv).

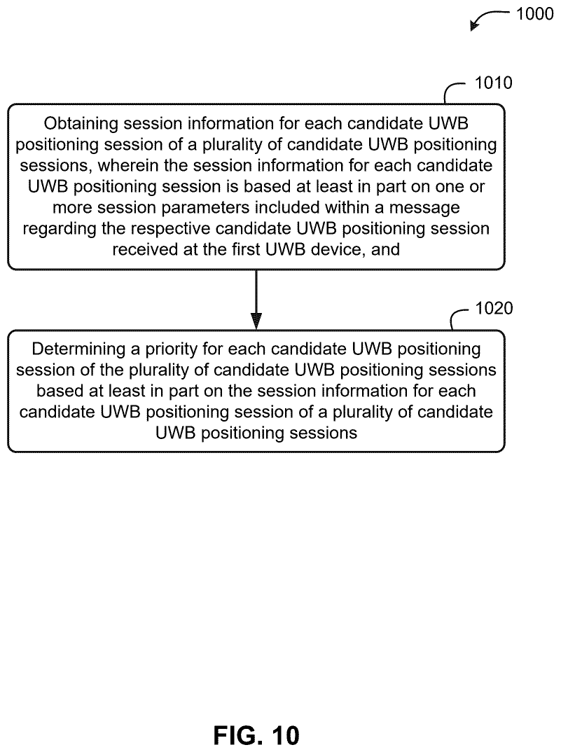

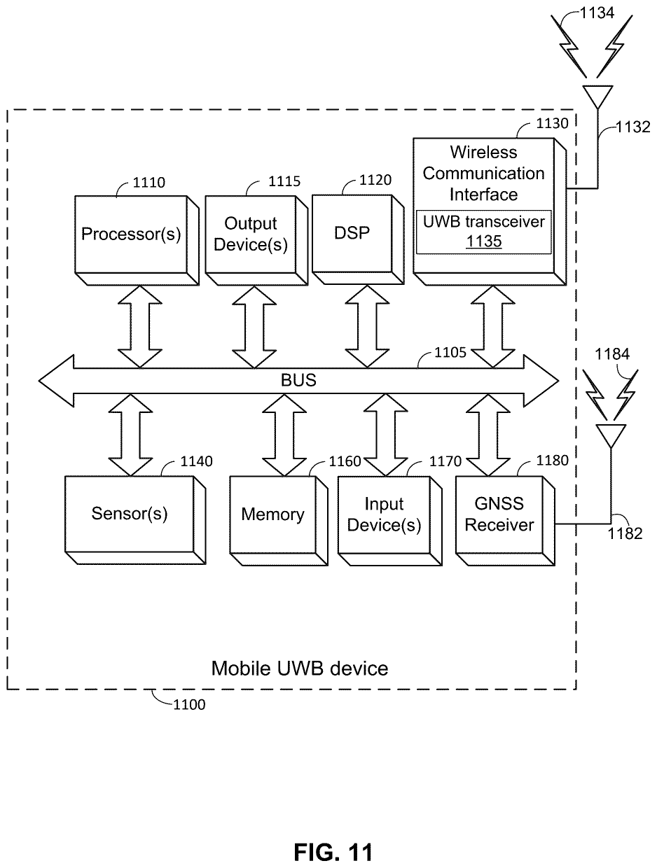

FIG. 10 is a flow diagram of a method 1000 of UWB positioning session prioritization for a first UWB device, according to an embodiment. Means for performing the functionality illustrated in one or more of the blocks shown in FIG. 10 may be performed by hardware and/or software components of a mobile UWB device, stationary UWB device, or server (e.g., CIE). Example components of a mobile UWB device, a stationary UWB device, and a server are respectively illustrated in FIGS. 11, 12, and 13, which are described in more detail below.

At block 1010, the functionality comprises obtaining session information for each candidate UWB positioning session of a plurality of candidate UWB positioning sessions, wherein the session information for each candidate UWB positioning session is based at least in part on one or more session parameters regarding the respective candidate UWB positioning session. The session information for each candidate UWB positioning session may be included within a message regarding the respective candidate UWB positioning session received at the first UWB device. The session information for each candidate UWB positioning session therefore may comprise the one or more session parameters for the candidate UWB positioning session and/or information derived therefrom. As noted in the previously-described embodiments, the one or more session parameters included with each message regarding a respective candidate UWB positioning session comprise a channel number for the respective candidate UWB positioning session; a location of a separate UWB device corresponding to the candidate UWB positioning session; a packet format configuration for use in the respective candidate UWB positioning session; a duration of a slot, round, or block, or any combination thereof, within the respective candidate UWB positioning session; a Scrambled Time Sequence (STS) configuration of the respective candidate UWB positioning session; an STS key rotation for the respective candidate UWB positioning session; a maximum number of controlee UWB devices that may participate in the respective candidate UWB positioning session; a current number of controlee UWB devices are participating in the respective candidate UWB positioning session; a clock drift accuracy of a separate UWB device corresponding to the candidate UWB positioning session; or a UWB initiation time of the candidate UWB positioning session; or a combination thereof. As also noted, RSS and/or SNR of a broadcast message may be used for determination of a priority. As such, for some embodiments of the method 1000, the session information for each candidate UWB positioning session of a plurality of candidate UWB positioning sessions a further comprise an RSS and/or SNR of the message regarding the respective candidate UWB positioning session received at the first UWB device.

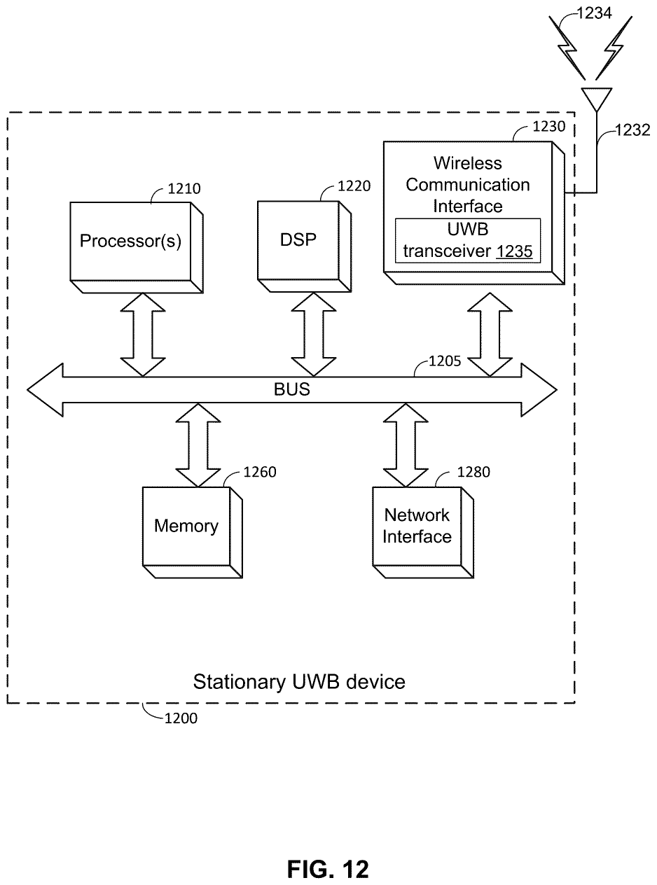

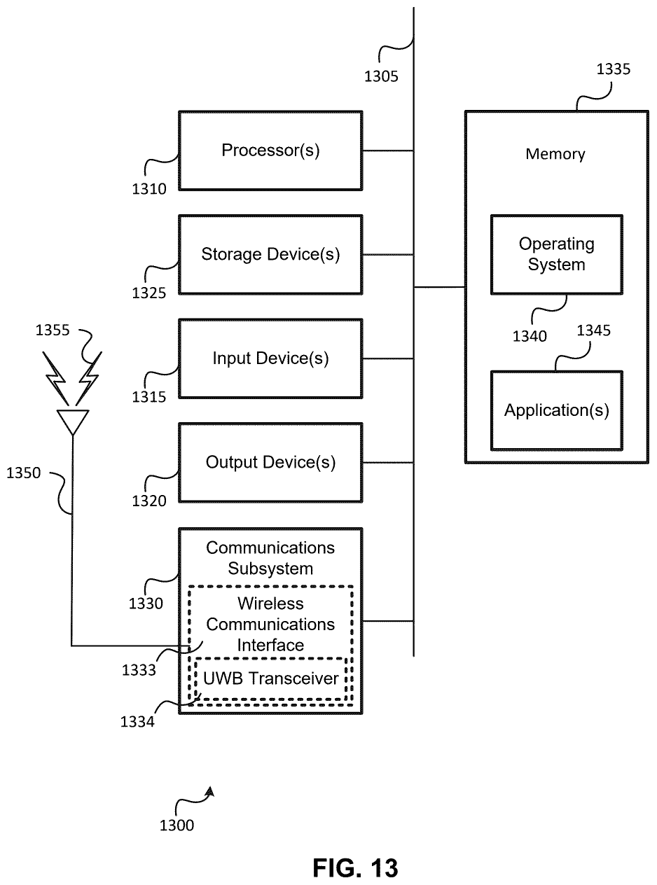

Means for performing functionality at block 1010 may comprise a bus 1105, processor(s) 1110, DSP 1120, memory 1160, wireless communication interface 1130 (e.g., including UWB transceiver 1334), and/or other components of a mobile UWB device 1100, as illustrated in FIG. 11. Additionally or alternatively, means for performing functionality at block 1010 may comprise a bus 1205, processor(s) 1210, DSP 1220, memory 1260, wireless communication interface 1230 (e.g., including UWB transceiver 1235), and/or other components of a stationary UWB device 1200, as illustrated in FIG. 12. Additionally or alternatively, means for performing functionality at block 1010 may comprise a bus 1305, processor(s) 1310, memory 1335, communications subsystem 1330 (e.g., including optional wireless communication interface 1333 and/or optional UWB transceiver 1334), and/or other components of a computer system 1300, as illustrated in FIG. 13.

At block 1020, the functionality comprises determining a priority for each candidate UWB positioning session of the plurality of candidate UWB positioning sessions based at least in part on the session information for each candidate UWB positioning session of a plurality of candidate UWB positioning sessions. According to some embodiments, this may not mean determining a priority for all candidate UWB positioning sessions for which the first UWB device may have received messages (e.g., broadcast by anchor or other UW be devices), however it may mean that a priority is determined for at least a plurality of candidate UWB positioning sessions in which the first UWB device may participate.

As noted, prioritization may be determined by the controlee UWB device (e.g., first UWB device) or a server communicatively coupled therewith. Thus, according to some embodiments of the method 1000, the session information may comprise determining the session information at the first UWB device, and the priority for each candidate UWB positioning session of the plurality of candidate UWB positioning sessions may comprise determining the priority for each candidate UWB positioning session of the plurality of candidate UWB positioning sessions at the first UWB device. Further, the method 1000 may further comprise participating in one or more of the plurality of candidate UWB positioning sessions based at least in part on the determined priority.

When the method 1000 is performed by a server communicatively coupled with the first UWB device, the server may perform corresponding functionality. For example, when the method 1000 is performed by a server, obtaining the session information may comprise receiving the session information at a server from the first UWB device, and determining the priority for each candidate UWB positioning session of the plurality of candidate UWB positioning sessions comprises determining the priority for each candidate UWB positioning session of the plurality of candidate UWB positioning sessions using the server. In such instances, the method may further comprise sending, from the server to the first UWB device, an indication of the determined priority for each candidate UWB positioning session of the plurality of candidate UWB positioning sessions. According to some embodiments, the indication of the determined priority for each candidate UWB positioning session of the plurality of candidate UWB positioning sessions comprises an indication of one or more of the plurality of candidate UWB positioning sessions in which the first UWB device is to participate. As noted, according to some embodiments, the server may further include a slot for the first UWB device to use during the UWB positioning session (or a range of slots the first UWB device may participate in, from which the first UWB device may select). As noted, the server may also make a prioritization determination based on the functionality of other devices (e.g., UWB devices, or devices operating in other wireless technologies). Thus, according to some embodiments, determining a priority for each candidate UWB positioning session of the plurality of candidate UWB positioning sessions further may be based at least in part on session information obtained from one or more additional UWB devices. Additionally or alternatively, determining the priority for each candidate UWB positioning session of the plurality of candidate UWB positioning sessions further may be based at least in part on historical channel usage by another technology, expected channel usage by another technology during the candidate UWB positioning session, or both.

Means for performing functionality at block 1020 may comprise a bus 1105, processor(s) 1110, DSP 1120, memory 1160, wireless communication interface 1130 (e.g., including UWB transceiver 1334), and/or other components of a mobile UWB device 1100, as illustrated in FIG. 11. Additionally or alternatively, means for performing functionality at block 1020 may comprise a bus 1205, processor(s) 1210, DSP 1220, memory 1260, wireless communication interface 1230 (e.g., including UWB transceiver 1235), and/or other components of a stationary UWB device 1200, as illustrated in FIG. 12. Additionally or alternatively, means for performing functionality at block 1020 may comprise a bus 1305, processor(s) 1310, memory 1335, communications subsystem 1330 (e.g., including optional wireless communication interface 1333 and/or optional UWB transceiver 1334), and/or other components of a computer system 1300, as illustrated in FIG. 13.

FIG. 11 is a block diagram of an embodiment of a mobile UWB device 1100, which can be utilized as described herein above (e.g., in association with FIGS. 1-10). For example, the Mobile UWB device 1100 can perform one or more of the functions of the method shown in FIG. 10. It should be noted that FIG. 11 is meant only to provide a generalized illustration of various components, any or all of which may be utilized as appropriate. For example, more basic/simple types of UWB devices may omit various components that may be included in more advanced/complex UWB devices. Furthermore, as previously noted, the functionality of the UE discussed in the previously described embodiments may be executed by one or more of the hardware and/or software components illustrated in FIG. 11.

The mobile UWB device 1100 is shown comprising hardware elements that can be electrically coupled via a bus 1105 (or may otherwise be in communication, as appropriate). The hardware elements may include a processor(s) 1110 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1110 may comprise one or more processing units, which may be housed in a single integrated circuit (IC) or multiple ICs. As shown in FIG. 11, some embodiments may have a separate DSP 1120, depending on desired functionality. Location determination and/or other determinations based on wireless communication may be provided in the processor(s) 1110 and/or wireless communication interface 1130 (discussed below). The mobile UWB device 1100 also can include one or more input devices 1170, which can include without limitation one or more keyboards, touch screens, touch pads, microphones, buttons, dials, switches, and/or the like; and one or more output devices 1115, which can include without limitation one or more displays (e.g., touch screens), light emitting diodes (LEDs), speakers, and/or the like.

The mobile UWB device 1100 may also include a wireless communication interface 1130, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the mobile UWB device 1100 to communicate with other devices as described in the embodiments above. The wireless communication interface 1130 may permit data and signaling to be communicated (e.g., transmitted and received) with access points, various base stations and/or other access node types, and/or other network components, computer systems, and/or any other electronic devices communicatively coupled therewith. The communication can be carried out via one or more wireless communication antenna(s) 1132 that send and/or receive wireless signals 1134. According to some embodiments, the wireless communication antenna(s) 1132 may comprise a plurality of discrete antennas, antenna arrays, or any combination thereof. The antenna(s) 1132 may be capable of transmitting and receiving wireless signals using beams (e.g., Tx beams and Rx beams). Beam formation may be performed using digital and/or analog beam formation techniques, with respective digital and/or analog circuitry. The wireless communication interface 1130 may include such circuitry.

As illustrated, the wireless indication interface 1130 may further comprise a UWB transceiver 1135. The UWB transceiver 1135 may be operated to perform the UWB operations described herein. Further, the wireless communications interface 1130 may comprise one or more additional communication technologies with which the OOB functionalities described herein may be performed. According to some embodiments, the UWB transceiver 1135 may be one of a plurality of UWB transceivers of the mobile UWB device 1100. Further, the UWB transceiver may be used for functionality in addition to the UWB positioning functionality described herein. Although illustrated as part of the wireless communication interface 1130, the UWB transceiver 1135 may be separate from the wireless communication interface 1130 in some embodiments.

Depending on desired functionality, the wireless communication interface 1130 may comprise a separate receiver and transmitter, or any combination of transceivers, transmitters, and/or receivers to communicate with base stations (e.g., ng-eNBs and gNBs) and other terrestrial transceivers, such as wireless devices and access points. The mobile UWB device 1100 may communicate with different data networks that may comprise various network types. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA 2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The mobile UWB device 1100 can further include sensor(s) 1140. Sensor(s) 1140 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the mobile UWB device 1100 may also include a Global Navigation Satellite System (GNSS) receiver 1180 capable of receiving signals 1184 from one or more GNSS satellites using an antenna 1182 (which could be the same as antenna 1132). Positioning based on GNSS signal measurement can be utilized to complement and/or incorporate the techniques described herein. The GNSS receiver 1180 can extract a position of the mobile UWB device 1100, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1180 can be used with various+storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1160 of the mobile UWB device 1100 also can comprise software elements (not shown in FIG. 11), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1160 that are executable by the mobile UWB device 1100 (and/or processor(s) 1110 or DSP 1120 within mobile UWB device 1100). In some embodiments, then, such code and/or instructions can be used to configure and/or adapt a general-purpose computer (or other device) to perform one or more operations in accordance with the described methods.

FIG. 12 is a block diagram of an embodiment of a stationary UWB device 1200, which can be utilized as described herein above (e.g., in association with FIGS. 1-10). It should be noted that FIG. 12 is meant only to provide a generalized illustration of various components, any or all of which may be utilized as appropriate. In some embodiments, the UWB anchor 1200 may correspond to an anchor UWB having a known location, which may be used to determine the location of other UWB devices, including mobile UWB devices. According to some embodiments, the stationary UWB device 1200 may be permanently stationary or temporarily stationary.

The stationary UWB device 1200 is shown comprising hardware elements that can be electrically coupled via a bus 1205 (or may otherwise be in communication, as appropriate). The hardware elements may include a processor(s) 1210 which can include without limitation one or more general-purpose processors, one or more special-purpose processors (such as DSP chips, graphics acceleration processors, ASICs, and/or the like), and/or other processing structure or means. As shown in FIG. 12, some embodiments may have a separate DSP 1220, depending on desired functionality. Location determination and/or other determinations based on wireless communication may be provided in the processor(s) 1210 and/or wireless communication interface 1230 (discussed below), according to some embodiments. The stationary UWB device 1200 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The stationary UWB device 1200 might also include a wireless communication interface 1230, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the stationary UWB device 1200 to communicate as described herein. The wireless communication interface 1230 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 1232 that send and/or receive wireless signals 1234.

As illustrated, the wireless indication interface 1130 may further comprise a UWB transceiver 1135. The UWB transceiver 1135 may be operated to perform the UWB operations described herein. Further, the wireless communications interface 1130 may comprise one or more additional communication technologies with which the OOB functionalities described herein may be performed. According to some embodiments, the UWB transceiver 1135 may be one of a plurality of UWB transceivers of the mobile UWB device 1100. Further, the UWB transceiver may be used for functionality in addition to the UWB positioning functionality described herein. Although illustrated as part of the wireless communication interface 1130, the UWB transceiver 1135 may be separate from the wireless communication interface 1130 in some embodiments.

The stationary UWB device 1200 may also include a network interface 1280, which can include support of wireline communication technologies. The network interface 1280 may include a modem, network card, chipset, and/or the like. The network interface 1280 may include one or more input and/or output communication interfaces to permit data to be exchanged with a network, communication network servers, computer systems, and/or any other electronic devices described herein. In some embodiments, the stationary UWB device 1200 may be communicatively coupled with one or more servers and/or other stationary UWB devices via the network interface 1280.

In many embodiments, the stationary UWB device 1200 may further comprise a memory 1260. The memory 1260 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1260 of the stationary UWB device 1200 also may comprise software elements (not shown in FIG. 12), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1260 that are executable by the stationary UWB device 1200 (and/or processor(s) 1210 or DSP 1220 within stationary UWB device 1200). In some embodiments, then, such code and/or instructions can be used to configure and/or adapt a general-purpose computer (or other device) to perform one or more operations in accordance with the described methods.

FIG. 13 is a block diagram of an embodiment of a computer system 1300, which may be used, in whole or in part, to provide the functions of a server as described in the embodiments herein (e.g., server/CIE of FIG. 9). It should be noted that FIG. 13 is meant only to provide a generalized illustration of various components, any or all of which may be utilized as appropriate. FIG. 13, therefore, broadly illustrates how individual system elements may be implemented in a relatively separated or relatively more integrated manner. In addition, it can be noted that components illustrated by FIG. 13 can be localized to a single device and/or distributed among various networked devices, which may be disposed at different geographical locations.

The computer system 1300 is shown comprising hardware elements that can be electrically coupled via a bus 1305 (or may otherwise be in communication, as appropriate). The hardware elements may include processor(s) 1310, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1300 also may comprise one or more input devices 1315, which may comprise without limitation a mouse, a keyboard, a camera, a microphone, and/or the like; and one or more output devices 1320, which may comprise without limitation a display device, a printer, and/or the like.

The computer system 1300 may further include (and/or be in communication with) one or more non-transitory storage devices 1325, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1300 may also include a communications subsystem 1330, which may (optionally, as indicated by dotted lines) comprise wireless communication technologies managed and controlled by a wireless communication interface 1333, as well as wired technologies (such as Ethernet, coaxial communications, universal serial bus (USB), and the like). The wireless communication interface 1333 may comprise one or more wireless transceivers that may send and receive wireless signals 1355 (e.g., signals according to 5G NR or LTE) via wireless antenna(s) 1350. Optionally, these one or more wireless transceivers may comprise a UWB transceiver 1334. Thus the communications subsystem 1330 may comprise a modem, a network card (wireless or wired), an infrared communication device, a wireless communication device, and/or a chipset, and/or the like, which may enable the computer system 1300 to communicate on any or all of the communication networks described herein to any device on the respective network. Hence, the communications subsystem 1330 may be used to receive and send data as described in the embodiments herein.

In many embodiments, the computer system 1300 will further comprise a working memory 1335, which may comprise a RAM or ROM device, as described above. Software elements, shown as being located within the working memory 1335, may comprise an operating system 1340, device drivers, executable libraries, and/or other code, such as one or more applications 1345, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general-purpose computer (or other device) to perform one or more operations in accordance with the described methods.

A set of these instructions and/or code might be stored on a non-transitory computer-readable storage medium, such as the storage device(s) 1325 described above. In some cases, the storage medium might be incorporated within a computer system, such as computer system 1300. In other embodiments, the storage medium might be separate from a computer system (e.g., a removable medium, such as an optical disc), and/or provided in an installation package, such that the storage medium can be used to program, configure, and/or adapt a general-purpose computer with the instructions/code stored thereon. These instructions might take the form of executable code, which is executable by the computer system 1300 and/or might take the form of source and/or installable code, which, upon compilation and/or installation on the computer system 1300 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method of ultra-wideband (UWB) positioning session prioritization for a first UWB device, the method comprising: obtaining session information for each candidate UWB positioning session of a plurality of candidate UWB positioning sessions, wherein the session information for each candidate UWB positioning session is based at least in part on one or more session parameters included within a message regarding the respective candidate UWB positioning session received at the first UWB device, and determining a priority for each candidate UWB positioning session of the plurality of candidate UWB positioning sessions based at least in part on the session information for each candidate UWB positioning session of a plurality of candidate UWB positioning sessions.

Clause 2. The method of clause 1, wherein the one or more session parameters included with each message regarding a respective candidate UWB positioning session comprise: a channel number for the respective candidate UWB positioning session; a location of a separate UWB device corresponding to the candidate UWB positioning session; a packet format configuration for use in the respective candidate UWB positioning session; a duration of a slot, round, or block, or any combination thereof, within the respective candidate UWB positioning session; a Scrambled Time Sequence (STS) configuration of the respective candidate UWB positioning session; an STS key rotation for the respective candidate UWB positioning session; a maximum number of controlee UWB devices that may participate in the respective candidate UWB positioning session; a current number of controlee UWB devices are participating in the respective candidate UWB positioning session; a clock drift accuracy of a separate UWB device corresponding to the candidate UWB positioning session; a UWB initiation time of the candidate UWB positioning session; or a combination thereof.

Clause 3. The method of any one of clauses 1-2 wherein the session information for each candidate UWB positioning session of a plurality of candidate UWB positioning sessions further comprises a received signal strength (RSS), a signal-to-noise ratio (SNR), or both, of the message regarding the respective candidate UWB positioning session received at the first UWB device.

Clause 4. The method of any one of clauses 1-3 wherein obtaining the session information comprises determining the session information at the first UWB device; determining the priority for each candidate UWB positioning session of the plurality of candidate UWB positioning sessions comprises determining the priority for each candidate UWB positioning session of the plurality of candidate UWB positioning sessions at the first UWB device; and wherein the method further comprises participating in one or more of the plurality of candidate UWB positioning sessions based at least in part on the determined priority.

Clause 5. The method of any one of clauses 1-3 wherein obtaining the session information comprises receiving the session information at a server from the first UWB device; determining the priority for each candidate UWB positioning session of the plurality of candidate UWB positioning sessions comprises determining the priority for each candidate UWB positioning session of the plurality of candidate UWB positioning sessions using the server; and wherein the method further comprises sending, from the server to the first UWB device, an indication of the determined priority for each candidate UWB positioning session of the plurality of candidate UWB positioning sessions.

Clause 6. The method of clause 5 wherein the indication of the determined priority for each candidate UWB positioning session of the plurality of candidate UWB positioning sessions comprises an indication of one or more of the plurality of candidate UWB positioning sessions in which the first UWB device is to participate.

Clause 7. The method of any one of clauses 5-6 wherein determining the priority for each candidate UWB positioning session of the plurality of candidate UWB positioning sessions is further based at least in part on session information obtained from one or more additional UWB devices.

Clause 8. The method of any one of clauses 5-7 wherein determining the priority for each candidate UWB positioning session of the plurality of candidate UWB positioning sessions is further based at least in part on historical channel usage by another technology, expected channel usage by another technology during the candidate UWB positioning session, or both.

Clause 9. A device comprising: a transceiver; a memory; and one or more processors communicatively coupled with the transceiver and the memory, wherein the one or more processors are configured to: obtain session information for each candidate ultra-wideband (UWB) positioning session of a plurality of candidate UWB positioning sessions, wherein the session information for each candidate UWB positioning session is based at least in part on one or more session parameters included within a message regarding the respective candidate UWB positioning session received at a first UWB device, and determine a priority for each candidate UWB positioning session of the plurality of candidate UWB positioning sessions based at least in part on the session information for each candidate UWB positioning session of a plurality of candidate UWB positioning sessions.

Clause 10. The device of clause 9, wherein the device comprises the first UWB device or a server communicatively coupled with the first UWB device.

Clause 11. The device of any one of clauses 9-10 wherein to obtain the session information, the one or more processors are configured to obtain session information comprising the one or more session parameters, and wherein the one or more session parameters comprise: a channel number for the respective candidate UWB positioning session; a location of a separate UWB device corresponding to the candidate UWB positioning session; a packet format configuration for use in the respective candidate UWB positioning session; a duration of a slot, round, or block, or any combination thereof, within the respective candidate UWB positioning session; a Scrambled Time Sequence (STS) configuration of the respective candidate UWB positioning session; an STS key rotation for the respective candidate UWB positioning session; a maximum number of controlee UWB devices that may participate in the respective candidate UWB positioning session; a current number of controlee UWB devices are participating in the respective candidate UWB positioning session; a clock drift accuracy of a separate UWB device corresponding to the candidate UWB positioning session; a UWB initiation time of the candidate UWB positioning session; or a combination thereof.

Clause 12. The device of any one of clauses 9-11 wherein to obtain the session information, the one or more processors are configured obtain to a received signal strength (RSS), a signal-to-noise ratio (SNR), or both, of the message regarding the respective candidate UWB positioning session received at the first UWB device.

Clause 13. The device of any one of clauses 9-12 wherein to obtain the session information, the one or more processors are configured to determine the session information at the first UWB device; to determine the priority for each candidate UWB positioning session of the plurality of candidate UWB positioning sessions, the one or more processors are configured to determine the priority for each candidate UWB positioning session of the plurality of candidate UWB positioning sessions; and wherein the one or more processors are further configured to participate in one or more of the plurality of candidate UWB positioning sessions based at least in part on the determined priority.

Clause 14. The device of any one of clauses 9-12 wherein to obtain the session information, the one or more processors are configured to receive the session information via the transceiver from the first UWB device; to determine the priority for each candidate UWB positioning session of the plurality of candidate UWB positioning sessions, the one or more processors are configured to determine the priority for each candidate UWB positioning session of the plurality of candidate UWB positioning sessions; and wherein the one or more processors are further configured to send, to the first UWB device, an indication of the determined priority for each candidate UWB positioning session of the plurality of candidate UWB positioning sessions.

Clause 15. The device of clause 14 wherein, to send the indication of the determined priority for each candidate UWB positioning session of the plurality of candidate UWB positioning sessions, the one or more processors are configured to send an indication of one or more of the plurality of candidate UWB positioning sessions in which the first UWB device is to participate.

Clause 16. The device of any one of clauses 14-15 wherein the one or more processors are configured to determine the priority for each candidate UWB positioning session of the plurality of candidate UWB positioning sessions further based at least in part on session information obtained from one or more additional UWB devices.

Clause 17. The device of any one of clauses 14-16 wherein the one or more processors are configured to determine the priority for each candidate UWB positioning session of the plurality of candidate UWB positioning sessions further based at least in part on historical channel usage by another technology, expected channel usage by another technology during the candidate UWB positioning session, or both.

Clause 18. An apparatus for ultra-wideband (UWB) positioning session prioritization for a first UWB device, the apparatus comprising: means for obtaining session information for each candidate UWB positioning session of a plurality of candidate UWB positioning sessions, wherein the session information for each candidate UWB positioning session is based at least in part on one or more session parameters included within a message regarding the respective candidate UWB positioning session received at the first UWB device, and means for determining a priority for each candidate UWB positioning session of the plurality of candidate UWB positioning sessions based at least in part on the session information for each candidate UWB positioning session of a plurality of candidate UWB positioning sessions.

Clause 19. The apparatus of clause 18, wherein the means for obtaining session information comprise means for obtaining the one or more session parameters, the one or more session parameters comprising: a channel number for the respective candidate UWB positioning session; a location of a separate UWB device corresponding to the candidate UWB positioning session; a packet format configuration for use in the respective candidate UWB positioning session; a duration of a slot, round, or block, or any combination thereof, within the respective candidate UWB positioning session; a Scrambled Time Sequence (STS) configuration of the respective candidate UWB positioning session; an STS key rotation for the respective candidate UWB positioning session; a maximum number of controlee UWB devices that may participate in the respective candidate UWB positioning session; a current number of controlee UWB devices are participating in the respective candidate UWB positioning session; a clock drift accuracy of a separate UWB device corresponding to the candidate UWB positioning session; a UWB initiation time of the candidate UWB positioning session; or a combination thereof.

Clause 20. The apparatus of any one of clauses 18-19 wherein the means for obtaining the session information for each candidate UWB positioning session of a plurality of candidate UWB positioning sessions further comprises means for obtaining a received signal strength (RSS), a signal-to-noise ratio (SNR), or both, of the message regarding the respective candidate UWB positioning session received at the first UWB device.

Clause 21. The apparatus of any one of clauses 18-20 wherein the means for obtaining the session information comprises means for determining the session information at the first UWB device; the means for determining the priority for each candidate UWB positioning session of the plurality of candidate UWB positioning sessions comprises means for determining the priority for each candidate UWB positioning session of the plurality of candidate UWB positioning sessions at the first UWB device; and the apparatus further comprises means for participating in one or more of the plurality of candidate UWB positioning sessions based at least in part on the determined priority.

Clause 22. The apparatus of any one of clauses 18-20 wherein the means for obtaining the session information comprises means for receiving the session information at a server from the first UWB device; the means for determining the priority for each candidate UWB positioning session of the plurality of candidate UWB positioning sessions comprises determining the priority for each candidate UWB positioning session of the plurality of candidate UWB positioning sessions using the server; and the apparatus further comprises means for sending, from the server to the first UWB device, an indication of the determined priority for each candidate UWB positioning session of the plurality of candidate UWB positioning sessions.

Clause 23. The apparatus of clause 22 wherein the means for sending the indication of the determined priority for each candidate UWB positioning session of the plurality of candidate UWB positioning sessions comprises means for sending an indication of one or more of the plurality of candidate UWB positioning sessions in which the first UWB device is to participate.

Clause 24. A non-transitory computer-readable medium storing instructions for ultra-wideband (UWB) positioning session prioritization for a first UWB device, the instructions comprising code for: obtaining session information for each candidate UWB positioning session of a plurality of candidate UWB positioning sessions, wherein the session information for each candidate UWB positioning session is based at least in part on one or more session parameters included within a message regarding the respective candidate UWB positioning session received at the first UWB device, and determining a priority for each candidate UWB positioning session of the plurality of candidate UWB positioning sessions based at least in part on the session information for each candidate UWB positioning session of a plurality of candidate UWB positioning sessions.

Clause 25. The computer-readable medium of clause 24, wherein the one or more session parameters included with each message regarding a respective candidate UWB positioning session comprise: a channel number for the respective candidate UWB positioning session; a location of a separate UWB device corresponding to the candidate UWB positioning session; a packet format configuration for use in the respective candidate UWB positioning session; a duration of a slot, round, or block, or any combination thereof, within the respective candidate UWB positioning session; a Scrambled Time Sequence (STS) configuration of the respective candidate UWB positioning session; an STS key rotation for the respective candidate UWB positioning session; a maximum number of controlee UWB devices that may participate in the respective candidate UWB positioning session; a current number of controlee UWB devices are participating in the respective candidate UWB positioning session; a clock drift accuracy of a separate UWB device corresponding to the candidate UWB positioning session; a UWB initiation time of the candidate UWB positioning session; or a combination thereof.

Clause 26. The computer-readable medium of any one of clauses 24-25 wherein the session information for each candidate UWB positioning session of a plurality of candidate UWB positioning sessions further comprises a received signal strength (RSS), a signal-to-noise ratio (SNR), or both, of the message regarding the respective candidate UWB positioning session received at the first UWB device.

Clause 27. The computer-readable medium of any one of clauses 24-26 wherein the code for obtaining the session information comprises code for determining the session information at the first UWB device; the code for determining the priority for each candidate UWB positioning session of the plurality of candidate UWB positioning sessions comprises code for determining the priority for each candidate UWB positioning session of the plurality of candidate UWB positioning sessions at the first UWB device; and the computer-readable medium further comprises code for participating in one or more of the plurality of candidate UWB positioning sessions based at least in part on the determined priority.

Clause 28. The computer-readable medium of any one of clauses 24-26 wherein the code for obtaining the session information comprises code for receiving the session information at a server from the first UWB device; the code for determining the priority for each candidate UWB positioning session of the plurality of candidate UWB positioning sessions comprises code for determining the priority for each candidate UWB positioning session of the plurality of candidate UWB positioning sessions using the server; and the computer-readable medium further comprises code for sending, from the server to the first UWB device, an indication of the determined priority for each candidate UWB positioning session of the plurality of candidate UWB positioning sessions.

Clause 29. The computer-readable medium of clause 28 wherein the code for sending the indication of the determined priority for each candidate UWB positioning session of the plurality of candidate UWB positioning sessions comprises code for sending an indication of one or more of the plurality of candidate UWB positioning sessions in which the first UWB device is to participate.

What is claimed is:

1. A method of ultra-wideband (UWB) positioning session prioritization for a first UWB device, the method comprising:
obtaining session information for each candidate UWB positioning session of a plurality of candidate UWB positioning sessions, wherein the session information for each candidate UWB positioning session is based at least in part on one or more session parameters included within a message regarding the respective candidate UWB positioning session received at the first UWB device, and
determining a priority for each candidate UWB positioning session of the plurality of candidate UWB positioning sessions based at least in part on the session information for each candidate UWB positioning session of a plurality of candidate UWB positioning sessions.

2. The method of claim 1, wherein the one or more session parameters included with each message regarding a respective candidate UWB positioning session comprise:
a channel number for the respective candidate UWB positioning session;
a location of a separate UWB device corresponding to the candidate UWB positioning session;
a packet format configuration for use in the respective candidate UWB positioning session;
a duration of a slot, round, or block, or any combination thereof, within the respective candidate UWB positioning session;
a Scrambled Time Sequence (STS) configuration of the respective candidate UWB positioning session;
an STS key rotation for the respective candidate UWB positioning session;
a maximum number of controlee UWB devices that may participate in the respective candidate UWB positioning session;
a current number of controlee UWB devices are participating in the respective candidate UWB positioning session;
a clock drift accuracy of a separate UWB device corresponding to the candidate UWB positioning session;
a UWB initiation time of the candidate UWB positioning session; or
a combination thereof.

3. The method of claim 1, wherein the session information for each candidate UWB positioning session of a plurality of candidate UWB positioning sessions further comprises a received signal strength (RSS), a signal-to-noise ratio (SNR), or both, of the message regarding the respective candidate UWB positioning session received at the first UWB device.

4. The method of claim 1, wherein:
obtaining the session information comprises determining the session information at the first UWB device;
determining the priority for each candidate UWB positioning session of the plurality of candidate UWB positioning sessions comprises determining the priority for each candidate UWB positioning session of the plurality of candidate UWB positioning sessions at the first UWB device; and
wherein the method further comprises participating in one or more of the plurality of candidate UWB positioning sessions based at least in part on the determined priority.

5. The method of claim 1, wherein:
obtaining the session information comprises receiving the session information at a server from the first UWB device;
determining the priority for each candidate UWB positioning session of the plurality of candidate UWB positioning sessions comprises determining the priority for each candidate UWB positioning session of the plurality of candidate UWB positioning sessions using the server; and
wherein the method further comprises sending, from the server to the first UWB device, an indication of the determined priority for each candidate UWB positioning session of the plurality of candidate UWB positioning sessions.

6. The method of claim 5, wherein the indication of the determined priority for each candidate UWB positioning session of the plurality of candidate UWB positioning sessions comprises an indication of one or more of the plurality of candidate UWB positioning sessions in which the first UWB device is to participate.

7. The method of claim 5, wherein determining the priority for each candidate UWB positioning session of the plurality of candidate UWB positioning sessions is further based at least in part on session information obtained from one or more additional UWB devices.

8. The method of claim 5, wherein determining the priority for each candidate UWB positioning session of the plurality of candidate UWB positioning sessions is further based at least in part on historical channel usage by another technology, expected channel usage by another technology during the candidate UWB positioning session, or both.

9. A device comprising:
a transceiver;
a memory; and
one or more processors communicatively coupled with the transceiver and the memory, wherein the one or more processors are configured to:
obtain session information for each candidate ultra-wideband (UWB) positioning session of a plurality of candidate UWB positioning sessions, wherein the session information for each candidate UWB positioning session is based at least in part on one or more session parameters included within a message regarding the respective candidate UWB positioning session received at a first UWB device, and
determine a priority for each candidate UWB positioning session of the plurality of candidate UWB positioning sessions based at least in part on the session information for each candidate UWB positioning session of a plurality of candidate UWB positioning sessions.

10. The device of claim 9, wherein the device comprises the first UWB device or a server communicatively coupled with the first UWB device.

11. The device of claim 9, wherein to obtain the session information, the one or more processors are configured to obtain session information comprising the one or more session parameters, and wherein the one or more session parameters comprise:
a channel number for the respective candidate UWB positioning session;
a location of a separate UWB device corresponding to the candidate UWB positioning session;
a packet format configuration for use in the respective candidate UWB positioning session;
a duration of a slot, round, or block, or any combination thereof, within the respective candidate UWB positioning session;
a Scrambled Time Sequence (STS) configuration of the respective candidate UWB positioning session;
an STS key rotation for the respective candidate UWB positioning session;
a maximum number of controlee UWB devices that may participate in the respective candidate UWB positioning session;
a current number of controlee UWB devices are participating in the respective candidate UWB positioning session;
a clock drift accuracy of a separate UWB device corresponding to the candidate UWB positioning session;
a UWB initiation time of the candidate UWB positioning session; or a combination thereof.

12. The device of claim 9, wherein to obtain the session information, the one or more processors are configured obtain to a received signal strength (RSS), a signal-to-noise ratio (SNR), or both, of the message regarding the respective candidate UWB positioning session received at the first UWB device.

13. The device of claim 9, wherein:
to obtain the session information, the one or more processors are configured to determine the session information at the first UWB device;
to determine the priority for each candidate UWB positioning session of the plurality of candidate UWB positioning sessions, the one or more processors are configured to determine the priority for each candidate UWB positioning session of the plurality of candidate UWB positioning sessions; and
wherein the one or more processors are further configured to participate in one or more of the plurality of candidate UWB positioning sessions based at least in part on the determined priority.

14. The device of claim 9, wherein:
to obtain the session information, the one or more processors are configured to receive the session information via the transceiver from the first UWB device;
to determine the priority for each candidate UWB positioning session of the plurality of candidate UWB positioning sessions, the one or more processors are configured to determine the priority for each candidate UWB positioning session of the plurality of candidate UWB positioning sessions; and
wherein the one or more processors are further configured to send, to the first UWB device, an indication of the determined priority for each candidate UWB positioning session of the plurality of candidate UWB positioning sessions.

15. The device of claim 14, wherein, to send the indication of the determined priority for each candidate UWB positioning session of the plurality of candidate UWB positioning sessions, the one or more processors are configured to send an indication of one or more of the plurality of candidate UWB positioning sessions in which the first UWB device is to participate.

16. The device of claim 14, wherein the one or more processors are configured to determine the priority for each candidate UWB positioning session of the plurality of candidate UWB positioning sessions further based at least in part on session information obtained from one or more additional UWB devices.

17. The device of claim 14, wherein the one or more processors are configured to determine the priority for each candidate UWB positioning session of the plurality of candidate UWB positioning sessions further based at least in part on historical channel usage by another technology, expected channel usage by another technology during the candidate UWB positioning session, or both.

18. An apparatus for ultra-wideband (UWB) positioning session prioritization for a first UWB device, the apparatus comprising:
means for obtaining session information for each candidate UWB positioning session of a plurality of candidate UWB positioning sessions, wherein the session information for each candidate UWB positioning session is based at least in part on one or more session parameters included within a message regarding the respective candidate UWB positioning session received at the first UWB device, and
means for determining a priority for each candidate UWB positioning session of the plurality of candidate UWB positioning sessions based at least in part on the session information for each candidate UWB positioning session of a plurality of candidate UWB positioning sessions.

19. The apparatus of claim 18, wherein the means for obtaining session information comprise means for obtaining the one or more session parameters, the one or more session parameters comprising:
a channel number for the respective candidate UWB positioning session;
a location of a separate UWB device corresponding to the candidate UWB positioning session;
a packet format configuration for use in the respective candidate UWB positioning session;
a duration of a slot, round, or block, or any combination thereof, within the respective candidate UWB positioning session;
a Scrambled Time Sequence (STS) configuration of the respective candidate UWB positioning session;
an STS key rotation for the respective candidate UWB positioning session;
a maximum number of controlee UWB devices that may participate in the respective candidate UWB positioning session;
a current number of controlee UWB devices are participating in the respective candidate UWB positioning session;
a clock drift accuracy of a separate UWB device corresponding to the candidate UWB positioning session;
a UWB initiation time of the candidate UWB positioning session; or
a combination thereof.

20. The apparatus of claim 18, wherein the means for obtaining the session information for each candidate UWB positioning session of a plurality of candidate UWB positioning sessions further comprises means for obtaining a received signal strength (RSS), a signal-to-noise ratio (SNR), or both, of the message regarding the respective candidate UWB positioning session received at the first UWB device.

21. The apparatus of claim 18, wherein:
the means for obtaining the session information comprises means for determining the session information at the first UWB device;
the means for determining the priority for each candidate UWB positioning session of the plurality of candidate UWB positioning sessions comprises means for determining the priority for each candidate UWB positioning session of the plurality of candidate UWB positioning sessions at the first UWB device; and
the apparatus further comprises means for participating in one or more of the plurality of candidate UWB positioning sessions based at least in part on the determined priority.

22. The apparatus of claim 18, wherein:
the means for obtaining the session information comprises means for receiving the session information at a server from the first UWB device;
the means for determining the priority for each candidate UWB positioning session of the plurality of candidate UWB positioning sessions comprises determining the priority for each candidate UWB positioning session of the plurality of candidate UWB positioning sessions using the server; and
the apparatus further comprises means for sending, from the server to the first UWB device, an indication of the determined priority for each candidate UWB positioning session of the plurality of candidate UWB positioning sessions.

23. The apparatus of claim 22, wherein the means for sending the indication of the determined priority for each candidate UWB positioning session of the plurality of candidate UWB positioning sessions comprises means for sending an indication of one or more of the plurality of candidate UWB positioning sessions in which the first UWB device is to participate.

24. A non-transitory computer-readable medium storing instructions for ultra-wideband (UWB) positioning session prioritization for a first UWB device, the instructions comprising code for:
obtaining session information for each candidate UWB positioning session of a plurality of candidate UWB positioning sessions, wherein the session information for each candidate UWB positioning session is based at least in part on one or more session parameters included within a message regarding the respective candidate UWB positioning session received at the first UWB device, and
determining a priority for each candidate UWB positioning session of the plurality of candidate UWB positioning sessions based at least in part on the session information for each candidate UWB positioning session of a plurality of candidate UWB positioning sessions.

25. The computer-readable medium of claim 24, wherein the one or more session parameters included with each message regarding a respective candidate UWB positioning session comprise:
a channel number for the respective candidate UWB positioning session;
a location of a separate UWB device corresponding to the candidate UWB positioning session;
a packet format configuration for use in the respective candidate UWB positioning session;
a duration of a slot, round, or block, or any combination thereof, within the respective candidate UWB positioning session;
a Scrambled Time Sequence (STS) configuration of the respective candidate UWB positioning session;
an STS key rotation for the respective candidate UWB positioning session;
a maximum number of controlee UWB devices that may participate in the respective candidate UWB positioning session;
a current number of controlee UWB devices are participating in the respective candidate UWB positioning session;
a clock drift accuracy of a separate UWB device corresponding to the candidate UWB positioning session;
a UWB initiation time of the candidate UWB positioning session; or
a combination thereof.

26. The computer-readable medium of claim 24, wherein the session information for each candidate UWB positioning session of a plurality of candidate UWB positioning sessions further comprises a received signal strength (RSS), a signal-to-noise ratio (SNR), or both, of the message regarding the respective candidate UWB positioning session received at the first UWB device.

27. The computer-readable medium of claim 24, wherein:
the code for obtaining the session information comprises code for determining the session information at the first UWB device;
the code for determining the priority for each candidate UWB positioning session of the plurality of candidate UWB positioning sessions comprises code for determining the priority for each candidate UWB positioning session of the plurality of candidate UWB positioning sessions at the first UWB device; and
the computer-readable medium further comprises code for participating in one or more of the plurality of candidate UWB positioning sessions based at least in part on the determined priority.

28. The computer-readable medium of claim 24, wherein:
the code for obtaining the session information comprises code for receiving the session information at a server from the first UWB device;
the code for determining the priority for each candidate UWB positioning session of the plurality of candidate UWB positioning sessions comprises code for determining the priority for each candidate UWB positioning session of the plurality of candidate UWB positioning sessions using the server; and
the computer-readable medium further comprises code for sending, from the server to the first UWB device, an indication of the determined priority for each candidate UWB positioning session of the plurality of candidate UWB positioning sessions.

29. The computer-readable medium of claim 28, wherein the code for sending the indication of the determined priority for each candidate UWB positioning session of the plurality of candidate UWB positioning sessions comprises code for sending an indication of one or more of the plurality of candidate UWB positioning sessions in which the first UWB device is to participate.
